(19) United States
(12) Patent Application Publication
(10) Pub. No.: US 2021/0256679 A1
(43) Pub. Date: Aug. 19, 2021

(54) SYSTEM FOR BUILDING PHOTOGRAMMETRY

(71) Applicant: Topcon Corporation, Tokyo (JP)

(72) Inventors: Yasufumi FUKUMA, Wako-shi (JP); Mao ZAIXING, Tokyo (JP); Satoshi YANOBE, Tokyo (JP); Toshio YAMADA, Tokyo (JP)

(73) Assignee: Topcon Corporation, Tokyo (JP)

(21) Appl. No.: 17/178,243

(22) Filed: Feb. 18, 2021

(30) Foreign Application Priority Data
Feb. 19, 2020 (JP) 2020-025808

(51) Int. Cl. G06T 7/00; G06T 19/00; G06K 9/00; G06K 9/62; G06T 7/50

(52) U.S. Cl. CPC G06T 7/001; G06T 19/003; G06K 9/00637; G06K 9/6256; G06T 2200/08; G06T 2210/04; G06T 2207/20084; G06T 2207/30108; G06T 2200/04; G06T 7/50

(57) ABSTRACT

The system 1 of an aspect example is used for building photogrammetry. The design data 141 includes virtual material information, which includes virtual material position information, on attributes for each virtual material of a virtual building. The physical material data 142, which includes physical material position data, is generated based on measured data of a physical building constructed based on the design data 141, relates to the attributes for each physical material. The material associating processor 151 generates pairs of virtual and physical materials by determining an association between the virtual and physical materials based on the virtual material position information and the physical material position data. For each of the pairs, the attribute associating processor 152 determines an association between the virtual material information and the physical material data in accordance with the attributes.

### CROSS-REFERENCE TO RELATED APPLICATION

This application is based upon and claims the benefit of priority from Japanese Patent Application No. 2020-025808, filed Feb. 19, 2020, the entire contents of which are incorporated herein by reference.

### BACKGROUND

Photogrammetry (also referred to as reality capture or the like) is a technology of creating a three dimensional model by acquiring data of a physical object (also referred to as a tangible object, a real object, a real tangible object, etc.) with a digital camera or a laser scanner. Photogrammetry is used in various kinds of fields such as measurement, virtual reality, and augmented reality (see, for example, U.S. Patent Publication No. 2016/0034137 and European Patent Publication No. 3522003). Applications of photogrammetry in the fields of architecture (building construction) and civil engineering have attracted attention in recent years.

In the field of architecture, the application of photogrammetry have been promoted for construction control or management, maintenance control or management, repair control or management, etc., and attempts have been made to combine photogrammetry with the following technologies (see, for example, the following documents; Japanese Unexamined Patent Application Publication No. 2018-116572, Japanese Unexamined Patent Application Publication No. 2018-119882, Japanese Unexamined Patent Application Publication No. 2018-124984, Japanese Unexamined Patent Application Publication No. 2018-151964, Japanese Unexamined Patent Application Publication No. 2019-023653, Japanese Unexamined Patent Application Publication No. 2019-105789, Japanese Unexamined Patent Application Publication No. 2019-194883, Japanese Unexamined Patent Application Publication No. 2019-219206, Japanese Unexamined Patent Application Publication No. 2020-004278, Japanese Unexamined Patent Application Publication No. 2020-008423): a mobile object (also referred to as a moving object, a moving body, etc.) such as an unmanned aerial vehicle (UAV) (or commonly known as a drone); a surveying instrument such as a total station; data processing technologies such as structure from motion (SfM), multi-view stereo (MVS), simultaneous localization and mapping (SLAM), and the like; and building information modeling (BIM).

The practical application and operation of such an integrated system in these fields requires integrated, efficient and consistent management of various kinds of data and information. However, such management methods and systems have not yet been realized.

### BRIEF SUMMARY OF THE INVENTION

Some aspect examples relate to a system for photogrammetry of a building. The system includes a memory, a material associating processor, and an attribute associating processor. The memory stores design data and physical material data. The design data includes virtual material information on a plurality of attributes for each of a plurality of virtual materials of a virtual building. The physical material data relates to the plurality of the attributes for each of a plurality of physical materials, and is generated based on measured data acquired from a physical building constructed on the basis of the design data. The material associating processor is configured to generate a plurality of pairs of virtual and physical materials by determining an association between the plurality of the virtual materials and the plurality of the physical materials based on the virtual material information and the physical material data. The attribute associating processor is configured to determine an association between the virtual material information and the physical material data in accordance with the plurality of the attributes for each of the plurality of the pairs. Further, the virtual material information includes virtual material position information. Furthermore, the physical material data includes physical material position data. In addition, the material associating processor is configured to generate the plurality of the pairs based on the virtual material position information and the physical material position data.

### BRIEF DESCRIPTION OF THE SEVERAL VIEWS OF THE DRAWINGS

FIG. 1 is a schematic diagram showing an example of the configuration of the system according to an aspect example.

FIG. 2 is a schematic diagram showing an example of the configuration of the virtual material information according to an aspect example.

FIG. 3 is a schematic diagram showing an example of the data structure of the virtual material information according to an aspect example.

FIG. 4 is a schematic diagram showing an example of the configuration of the physical material data according to an aspect example.

FIG. 5 is a schematic diagram showing an example of the data structure of the physical material data according to an aspect example.

FIG. 6 is a schematic diagram showing an example of the material associating process executed by the system according to an aspect example.

FIG. 7 is a schematic diagram showing an example of the attribute associating process executed by the system according to an aspect example.

FIG. 8 is a schematic diagram showing an example of the configuration of the system according to an aspect example.

FIG. 9 is a schematic diagram showing an example of the configuration of the system according to an aspect example.

FIG. 10 is a schematic diagram showing an example of the configuration of the system according to an aspect example.

FIG. 11 is a schematic diagram showing an example of the configuration of the system according to an aspect example.

FIG. 12 is a schematic diagram for describing an example of the process executed by the system according to an aspect example.

FIG. 13 is a schematic diagram showing an example of the configuration of the system according to an aspect example.

FIG. 14 is a schematic diagram showing an example of the configuration of the system according to a usage mode of an aspect example.

FIG. 15 is a schematic diagram showing an example of the data format (data structure) used in the system according to a usage mode of an aspect example.

FIG. 16A is a flowchart showing an example of the operation of the system according to a usage mode of an aspect example.

FIG. 16B is a flowchart showing an example of the operation of the system according to a usage mode of an aspect example.

FIG. 16C is a flowchart showing an example of the operation of the system according to a usage mode of an aspect example.

### DETAILED DESCRIPTION

One object of the present disclosure is to provide a new technique or technology for practical application and operation of building photogrammetry.

Some aspect examples relate to a structure of data to be processed by a building photogrammetry system, wherein the data comprises: design data prepared in advance that includes virtual material information on a plurality of attributes for each of a plurality of virtual materials of a virtual building; and physical material data on the plurality of the attributes for each of a plurality of physical materials, the physical material data being generated based on measured data acquired from a physical building constructed on the basis of the design data, and the data is used for: a material associating process of determining an association between the plurality of the virtual materials and the plurality of the physical materials based on the virtual material information and the physical material data; and an attribute associating process of determining an association between the virtual material information and the physical material data in accordance with the plurality of the attributes for each of a plurality of pairs of virtual material and physical material determined by the material associating process, wherein the virtual material information includes virtual material position information, the physical material data includes physical material position data, and the virtual material position information and the physical material position data are used in the material associating process.

Some aspect examples relate to a structure of data to be processed by a building photogrammetry system, wherein the data comprises: design data prepared in advance that includes virtual material information on a plurality of attributes for each of a plurality of virtual materials of a virtual building; physical material data on the plurality of the attributes for each of a plurality of physical materials, the physical material data being generated based on measured data acquired from a physical building constructed on the basis of the design data; and a virtual image of the virtual building generated in advance, and the data is used for: a material associating process of determining an association between the plurality of the virtual materials and the plurality of the physical materials based on the virtual material information and the physical material data; an attribute associating process of determining an association between the virtual material information and the physical material data in accordance with the plurality of the attributes for each of a plurality of pairs of virtual material and physical material determined by the material associating process; and a movement control information creating process of creating movement control information for acquiring data of a building using a mobile object based on the virtual image.

In some aspect examples of the data structure, the data to be processed by the building photogrammetry system further comprises a photographed image acquired in advance, wherein the photographed image is used for the movement control information creating process.

In some aspect examples of the data structure, the data to be processed by the building photogrammetry system further comprises an inference model configured to identify an image of a building material from a photographed image of a building, the inference model being created by applying machine learning using at least the virtual image to a neural network, wherein the inference model is used for the movement control information creating process.

Some aspect examples relate to a structure of data to be processed by a building photogrammetry system, wherein the data comprises: design data prepared in advance that includes virtual material information on a plurality of attributes for each of a plurality of virtual materials of a virtual building; physical material data on the plurality of the attributes for each of a plurality of physical materials, the physical material data being generated based on measured data acquired from a physical building constructed on the basis of the design data; and a virtual image of the virtual building generated in advance, and the data is used for: a material associating process of determining an association between the plurality of the virtual materials and the plurality of the physical materials based on the virtual material information and the physical material data; an attribute associating process of determining an association between the virtual material information and the physical material data in accordance with the plurality of the attributes for each of a plurality of pairs of virtual material and physical material determined by the material associating process; and a reference information creating process of creating, based on the virtual image, reference information for determining whether data of a building material is acquired in parallel with acquiring data of a building using a mobile object.

In some aspect examples of the data structure, the data to be processed by the building photogrammetry system further comprises a photographed image acquired in advance, wherein the photographed image is used for the reference information creating process.

In some aspect examples of the data structure, the data to be processed by the building photogrammetry system further comprises an inference model configured to identify an image of a building material from a photographed image of a building, the inference model being created by applying machine learning using at least the virtual image to a neural network, wherein the inference model is used for the reference information creating process.

Some aspect examples relate to a structure of data to be processed by a building photogrammetry system, wherein the data comprises: design data prepared in advance that includes virtual material information on a plurality of attributes for each of a plurality of virtual materials of a virtual building; physical material data on the plurality of the attributes for each of a plurality of physical materials, the physical material data being generated based on measured data acquired from a physical building constructed on the basis of the design data; a virtual image of the virtual building generated in advance; and data of a building acquired in advance, and the data is used for: a data object detecting process of detecting a data object from the data of the building based on the virtual image; a material associating process of determining an association between the plurality of the virtual materials and the plurality of the physical materials based on the virtual material information, the physical material data, and the data object detected by the data object detecting process; and an attribute associating process of determining an association between the virtual material information and the physical material data in accordance with the plurality of the attributes for each of a plurality of pairs of virtual material and physical material determined by the material associating process.

In some aspect examples of the data structure, the data to be processed by the building photogrammetry system further comprises a photographed image acquired in advance, wherein the photographed image is used for the data object detecting process.

In some aspect examples of the data structure, the data to be processed by the building photogrammetry system further comprises an inference model configured to identify an image of a building material from a photographed image of a building, the interference model being created by applying machine learning using at least the virtual image to a neural network, wherein the inference model is used for the data object detecting process.

Some aspect examples relate to a structure of data to be processed by a building photogrammetry system, wherein the data comprises: design data prepared in advance that includes virtual material information on a plurality of attributes for each of a plurality of virtual materials of a virtual building; representative part information created in advance that shows a representative part of a virtual material; measured data acquired from a physical building constructed based on the design data; and physical material data, generated based on the measured data, on the plurality of the attributes for each of a plurality of physical materials, and the data is used for: a material associating process of determining an association between the plurality of the virtual materials and the plurality of the physical materials based on the virtual material information and the physical material data; an attribute associating process of determining an association between the virtual material information and the physical material data in accordance with the plurality of the attributes for each of a plurality of pairs of virtual material and physical material determined by the material associating process; and a partial region identifying process of identifying a partial region of the measured data corresponding to a representative part of one of the plurality of the virtual materials, based on the representative part information.

In some aspect examples of the data structure, the partial region identified by the partial region identifying process is used in a physical material data generating process of generating the physical material data from the measured data.

Some aspect examples relate to a structure of data to be processed by a building photogrammetry system, wherein the data comprises: design data prepared in advance that includes virtual material information on a plurality of attributes for each of a plurality of virtual materials of a virtual building; material selection information, generated in advance based on the design data, that shows one or more virtual materials among the plurality of the virtual materials; measured data acquired from a physical building constructed based on the design data; and physical material data, generated based on the measured data, on the plurality of the attributes for each of a plurality of physical materials, and the data is used for: a material associating process of determining an association between the plurality of the virtual materials and the plurality of the physical materials based on the virtual material information and the physical material data; an attribute associating process of determining an association between the virtual material information and the physical material data in accordance with the plurality of the attributes for each of a plurality of pairs of virtual material and physical material determined by the material associating process; and a physical material data generating process of generating the physical material data from a partial region of the measured data corresponding to the one or more virtual materials shown in the material selection information.

Some aspect examples relate to a structure of data to be processed by a building photogrammetry system, wherein the data comprises: design data prepared in advance that includes virtual material information on a plurality of attributes for each of a plurality of virtual materials of a virtual building; and physical material data on the plurality of the attributes for each of a plurality of physical materials, the physical material data being generated based on measured data acquired from a physical building constructed on the basis of the design data, and the data is used for: a material associating process of determining an association between the plurality of the virtual materials and the plurality of the physical materials based on the virtual material information and the physical material data; and an attribute associating process of determining an association between the virtual material information and the physical material data in accordance with the plurality of the attributes for each of a plurality of pairs of virtual material and physical material determined by the material associating process, wherein the virtual material information includes installation date information that shows an installation date for each of the plurality of the virtual materials, the physical material data includes measurement date information that shows a measurement date of the physical building, and the installation date information and the measurement date information are used in the material associating process.

Some aspect examples relate to a computer-readable non-transitory recording medium that records data having the data structure according to any of the aspect examples.

Some aspect examples relate to a program configured to cause a computer included in a building photogrammetry system to execute processing in which data having the data structure according to any of the aspect examples is used.

Some aspect examples relate to a computer-readable non-transitory recording medium that stores the program according to any of the aspect examples.

Some aspect examples relate to a system for photogrammetry of a building that comprises: a memory that stores design data and physical material data, the design data including virtual material information on a plurality of attributes for each of a plurality of virtual materials of a virtual building, and the physical material data relating to the plurality of the attributes for each of a plurality of physical materials and being generated based on measured data acquired from a physical building constructed on the basis of the design data; a material associating processor configured to generate a plurality of pairs of virtual material and physical material by determining an association between the plurality of the virtual materials and the plurality of the physical materials based on the virtual material information and the physical material data; and an attribute associating processor configured to determine an association between the virtual material information and the physical material data in accordance with the plurality of the attributes for each of the plurality of the pairs, wherein the virtual material information includes virtual material position information, the physical material data includes physical material position data, and the material associating processor generates the plurality of the pairs based on the virtual material position information and the physical material position data.

Some aspect examples relate to a system for photogrammetry of a building that comprises: a memory that stores design data, a virtual image of a virtual building, and physical material data, the design data including virtual material information on a plurality of attributes for each of a plurality of virtual materials of the virtual building, and the physical material data relating to the plurality of the attributes for each of a plurality of physical materials and being generated based on measured data acquired from a physical building constructed on the basis of the design data; a material associating processor configured to generate a plurality of pairs of virtual material and physical material by determining an association between the plurality of the virtual materials and the plurality of the physical materials based on the virtual material information and the physical material data; an attribute associating processor configured to determine an association between the virtual material information and the physical material data in accordance with the plurality of the attributes for each of the plurality of the pairs; and a movement control information creating processor configured to create movement control information for acquiring data of a building using a mobile object based on the virtual image.

In some aspect examples of the building photogrammetry system, the memory further stores a photographed image, and the movement control information creating processor creates the movement control information based further on the photographed image.

In some aspect examples of the building photogrammetry system, the system further comprises an inference model creating processor configured to create an inference model for identifying an image of a building material from a photographed image of a building by applying machine learning using at least the virtual image to a neural network, wherein the movement control information creating processor creates the movement control information based further on the inference model.

Some aspect examples relate to a system for photogrammetry of a building that comprises: a memory that stores design data, a virtual image of a virtual building, and physical material data, the design data including virtual material information on a plurality of attributes for each of a plurality of virtual materials of the virtual building, and the physical material data relating to the plurality of the attributes for each of a plurality of physical materials and being generated based on measured data acquired from a physical building constructed on the basis of the design data; a material associating processor configured to generate a plurality of pairs of virtual material and physical material by determining an association between the plurality of the virtual materials and the plurality of the physical materials based on the virtual material information and the physical material data; an attribute associating processor configured to determine an association between the virtual material information and the physical material data in accordance with the plurality of the attributes for each of the plurality of the pairs; and a reference information creating processor configured to create, based on the virtual image, reference information for determining whether data of a building material is acquired in parallel with acquiring data of a building using a mobile object.

In some aspect examples of the building photogrammetry system, the memory further stores a photographed image, and the reference information creating processor creates the reference information based further on the photographed image.

In some aspect examples of the building photogrammetry system, the system further comprises an inference model creating processor configured to create an inference model for identifying an image of a building material from a photographed image of a building by applying machine learning using at least the virtual image to a neural network, wherein the reference information creating processor creates the reference information based further on the inference model.

Some aspect examples relate to a system for photogrammetry of a building that comprises: a memory that stores design data, a virtual image of a virtual building, physical material data, and data of a building, the design data including virtual material information on a plurality of attributes for each of a plurality of virtual materials of the virtual building, and the physical material data relating to the plurality of the attributes for each of a plurality of physical materials and being generated based on measured data acquired from a physical building constructed on the basis of the design data; a data object detecting processor configured to detect a data object from the data of the building based on the virtual image; a material associating processor configured to generate a plurality of pairs of virtual material and physical material by determining an association between the plurality of the virtual materials and the plurality of the physical materials based on the virtual material information, the physical material data, and the data object; and an attribute associating processor configured to determine an association between the virtual material information and the physical material data in accordance with the plurality of the attributes for each of the plurality of the pairs.

In some aspect examples of the building photogrammetry system, the memory further stores a photographed image, and the data object detecting processor detects the data object based further on the photographed image.

In some aspect examples of the building photogrammetry system, the system further comprises an inference model creating processor configured to create an inference model for identifying an image of a building material from a photographed image of a building by applying machine learning using at least the virtual image to a neural network, wherein the data object detecting processor detects the data object based further on the inference model.

Some aspect examples relate to a system for photogrammetry of a building that comprises: a memory that stores design data, representative part information, measured data, and physical material data, the design data including virtual material information on a plurality of attributes for each of a plurality of virtual materials of a virtual building, the representative part information showing a representative part of a virtual material, the measured data being acquired from a physical building constructed based on the design data, and the physical material data relating to the plurality of the attributes for each of a plurality of physical materials and being generated based on the measured data; a material associating processor configured to generate a plurality of pairs of virtual material and physical material by determining an association between the plurality of the virtual materials and the plurality of the physical materials based on the virtual material information and the physical material data; an attribute associating processor configured to determine an association between the virtual material information and the physical material data in accordance with the plurality of the attributes for each of the plurality of the pairs; and a partial region identifying processor configured to identify a partial region of the measured data corresponding to a representative part of one of the plurality of the virtual materials based on the representative part information.

In some aspect examples of the building photogrammetry system, the system further comprises a first physical material data generating processor configured to generate the physical material data from the measured data based on the partial region identified by the partial region identifying processor.

Some aspect examples relate to a system for photogrammetry of a building that comprises: a memory that stores design data, material selection information, measured data, and physical material data, the design data including virtual material information on a plurality of attributes for each of a plurality of virtual materials of a virtual building, the material selection information showing one or more virtual materials among the plurality of the virtual materials and being generated in advance based on the design data, the measured data being acquired from a physical building constructed based on the design data, and the physical material data relating to the plurality of the attributes for each of a plurality of physical materials and being generated based on the measured data; a material associating processor configured to generate a plurality of pairs of virtual material and physical material by determining an association between the plurality of the virtual materials and the plurality of the physical materials based on the virtual material information and the physical material data; an attribute associating processor configured to determine an association between the virtual material information and the physical material data in accordance with the plurality of the attributes for each of the plurality of the pairs; and a second physical material data generating processor configured to generate the physical material data from a partial region of the measured data corresponding to the one or more virtual materials based on the material selection information.

Some aspect examples relate to a system for photogrammetry of a building that comprises: a memory that stores design data and physical material data, the design data including virtual material information on a plurality of attributes for each of a plurality of virtual materials of a virtual building, and the physical material data relating to the plurality of the attributes for each of a plurality of physical materials and being generated based on measured data acquired from a physical building constructed on the basis of the design data; a material associating processor configured to generate a plurality of pairs of virtual material and physical material by determining an association between the plurality of the virtual materials and the plurality of the physical materials based on the virtual material information and the physical material data; and an attribute associating processor configured to determine an association between the virtual material information and the physical material data in accordance with the plurality of the attributes for each of the plurality of the pairs, wherein the virtual material information includes installation date information that shows an installation date for each of the plurality of the virtual materials, the physical material data includes measurement date information that shows a measurement date of the physical building, and the material associating processor generates the plurality of the pairs based further on the installation date information and the measurement date information.

The present disclosure describes some aspect examples of a data structure (data format), a recording medium on which data having a structure (format) is recorded, a program, a recording medium on which a program is recorded, and a system. While some aspect examples may be used to properly put into practical use and operate a building photogrammetry system (building reality capture system), the aspect examples may also be applied to a photogrammetry system in other fields. In addition, matters and items described in the documents cited in the present disclosure (the present specification) and any other known technologies or techniques may be employed in the aspect examples described herein.

At least one or more of the functions of the elements described in the present disclosure are implemented by using a circuit configuration (or circuitry) or a processing circuit configuration (or processing circuitry). The circuitry or the processing circuitry includes any of the followings, all of which are configured and/or programmed to execute at least one or more functions disclosed herein: a general purpose processor, a dedicated processor, an integrated circuit, a central processing unit (CPU), a graphics processing unit (GPU), an application specific integrated circuit (ASIC), a programmable logic device (e.g., a simple programmable logic device (SPLD), a complex programmable logic device (CPLD), or a field programmable gate array (FPGA)), a conventional circuit configuration or circuitry, and any combination of these. A processor is considered to be processing circuitry or circuitry that includes a transistor and/or another circuitry. In the present disclosure, circuitry, a unit, a means, or a term similar to these is hardware that executes at least one or more functions disclosed herein, or hardware that is programmed to execute at least one or more functions disclosed herein. Hardware may be the hardware disclosed herein, or alternatively, known hardware that is programmed and/or configured to execute at least one or more functions described herein. In the case where the hardware is a processor, which may be considered as a certain type of circuitry, then circuitry, a unit, a means, or a term similar to these is a combination of hardware and software. In this case, the software is used to configure the hardware and/or the processor.

Any two or more of the aspect examples described herein may be combined in any manner. For example, any two or more aspect examples may be at least partially combined.

### FIRST ASPECT EXAMPLE

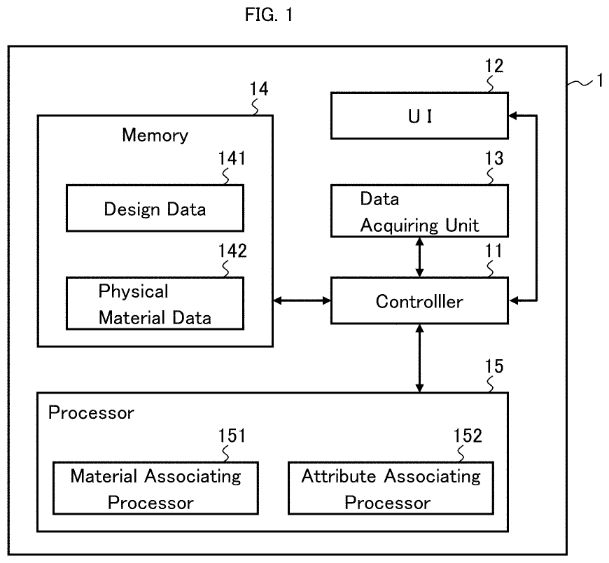

The first aspect example gives description of examples of elements, matters, and items common to the second to sixth aspect examples. FIG. 1 shows a configuration example of the system according to the present aspect example. The system 1 is included in a building photogrammetry system. The building photogrammetry system has the function of measuring an actual building and acquiring digital data. The building photogrammetry system of the present aspect example (also referred to as the system 1) is configured to generate a data structure (data format) for facilitating comparison between measured data of an actual building and design data thereof. The photogrammetry system of the present aspect example (the system 1) includes, for example, a data management system and a measurement system.

The system 1 according to the present aspect example includes at least the memory 14 and the processor 15, and may further includes the controller 11, the user interface (UI) 12, and the data acquiring unit 13.

The controller 11 is configured to execute various kinds of control processing of the system 1. The controller 11 is implemented, for example, by the cooperation of hardware including a processor and a storage device, and control software. The controller 11 may be included in a single computer or decentralized among two or more computers.

The user interface 12 includes, for example, a display device, an operation device, an input device, and the like. The user interface 12 of some aspect examples includes a graphical user interface (GUI) configured with hardware and software such as a touch screen, a pointing device, and computer graphics software. The user interface 12 may be included in a single computer or decentralized among two or more computers.

The data acquiring unit 13 is configured to execute either one or both of data generation and data reception. The data generation function includes, for example, any of the following functions: a function of acquiring data from a physical object; a function of processing data acquired from a physical object; a function of generating data using a computer; and a function of processing data generated in advance.

The function of acquiring data from a physical object may include, for example, either one or both of the following functions: a function of photographing the physical object with a camera (e.g., an omnidirectional camera, also known as a 360-degree camera) or a video camera (e.g., an omnidirectional video camera, also known as a 360-degree video camera) mounted on a mobile object such as an unmanned aerial vehicle (UAV) or carried by a person; and a function of acquiring data by scanning the physical object with a scanner such as a laser scanner or a total station. The data acquiring unit 13 having the function of acquiring data from a physical object may include one or more measuring apparatuses.

The function of processing data acquired from a physical object may be implemented, for example, by using at least a processor, and includes a function of applying a predetermined process to a photographed image or scan data of the physical object to generate other data. An example of this function is a data processing function implemented with any of SfM, MVS, SLAM (V-SLAM, or Visual SLAM) and the like described above. Another example is a data processing function with a learned model constructed using machine learning. The data acquiring unit 13 having the function of processing data acquired from a physical object may be included in a single computer or decentralized among two or more computers.

The function of generating data using a computer includes, for example, a data generating function with computer graphics, such as a function of generating data using a BIM application and a function of generating data using a computer-aided design (CAD) application. Hereinafter, data generated using a BIM application will be referred to as BIM data, and data generated using a CAD application will be referred to as CAD data. In addition to these functions, the function of generating data using a computer may include a function of generating data using various kinds of applications relating to architecture or construction such as a construction control or management application, a maintenance control or management application, and a repair control or management application. The data acquiring unit 13 having the function of generating data using a computer may be included in a single computer or decentralized among two or more computers.

The function of processing data generated in advance is implemented, for example, by using at least a processor, and includes a function of generating other data by applying a predetermined process to data of a physical object that has been acquired and/or processed in the past by any of the system 1, another apparatus, and another system. The technique or technology applicable to the function of processing data generated in advance may be the same as the technique or technology applicable to the function of processing data acquired from a physical object. BIM data is an example of the data generated in advance. The data acquiring unit 13 having the function of processing data generated in advance may be included in a single computer or decentralized among two or more computers.

The data reception function is a function of receiving data from the outside. The data reception function may be implemented, for example, by using a communication device for performing data communication with an external device, an external system, an external database, and the like. In addition to or in place of this, the data reception function may be implemented by using a drive device for reading out data recorded on a recording medium. The data received from the outside by the data acquiring unit 13 may be, for example, data generated by using a computer (e.g., BIM data, CAD data, etc.), or data that has been acquired and/or processed in the past by any of the system 1, another apparatus, and another system. The recording medium that can be employed for the data reception function is a computer-readable non-transitory recording medium, and examples thereof may include a magnetic disk, an optical disk, a magneto-optical disk, a semiconductor memory, or the like.

The physical object in the present aspect example is a building. A building is constructed based on design data generated in advance. Examples of the design data include BIM data, a design specification, a construction drawing, a working drawing, a working diagram, a construction document, a construction plan, a construction schedule, and the like. The building data recorded in the design data (and/or the building data obtained by processing the design data) in the present disclosure may be referred to as a virtual building, and a structural element or a component (building material) of the virtual building may be referred to as a virtual material. In some aspect examples, the virtual material is a material model provided by a BIM model, and a building structured or configured using a plurality of material models is a virtual building.

In addition, a real building constructed based on design data may be referred to as a physical building, and a structural element or a component (building material) or the physical building may be referred to as a physical material in the present disclosure. The aforementioned physical object corresponds to such a physical building. The physical building may not only be a building completed based on design data, but also be a building under construction (an uncompleted building), or even be a building site before construction.

The building materials in the present disclosure may include structural materials as well as non-structural materials, various kinds of parts, various kinds of machines, various kinds of devices or equipment, various kinds of facilities, and the like. Here, examples of the structural materials include columns, beams, walls, slabs, roofs, foundations, and the like, and examples of the non-structural materials include windows, doors, stairs, tiles, floorings, and the like. More generally, a building material in the present disclosure may be any type of thing or object that can be registered as a virtual material, and may be any type of thing or object that can be used as a physical material.

The memory 14 is configured to store various kinds of data (information). The memory 14 stores, for example, data acquired by the data acquiring unit 13. The memory 14 includes a storage device that has a relatively large capacity (e.g., memory, secondary storage) such as a hard disk drive (HDD) or a solid state drive (SSD), for example. The memory 14 include a single storage device or two or more storage devices. In the present aspect example, the memory 14 stores the design data 141 and the physical material data 142.

The design data 141 may be any data and/or any information relating to building design. The design data 141 may include, for example, BIM data, a design specification, a construction drawing, a working drawing, a working diagram, a construction document, a construction plan, a construction schedule, and the like. Further, the design data 141 may include data generated from any one or more pieces of data among any data and/or any information relating to building design such as BIM data, a design specification, a construction drawing, a working drawing, a working diagram, a construction document, a construction plan, a construction schedule.

The design data 141 in some aspect examples may be data of a virtual building (a plurality of virtual materials) designed using a BIM application (a BIM tool) that is arranged outside the system 1.

The design data 141 of the present aspect example includes virtual material information. The virtual material information includes information on a plurality of virtual materials that are structural elements or components of a virtual building. More specifically, the virtual material information includes information relating to a plurality of attributes set in advance for each of the plurality of the virtual materials. The attributes mean properties, features, characteristics, or the like of the virtual materials.

In some aspect examples, the plurality of attributes of the virtual materials includes, for example, virtual material identification information (virtual material ID), virtual material shape information, virtual material position information, material installation date information, and the like. Note that the attributes of the virtual materials are not limited to these items, and may be any types of property, feature, or characteristic such as a raw material, an ingredient, a constituent, a substance, or the like.

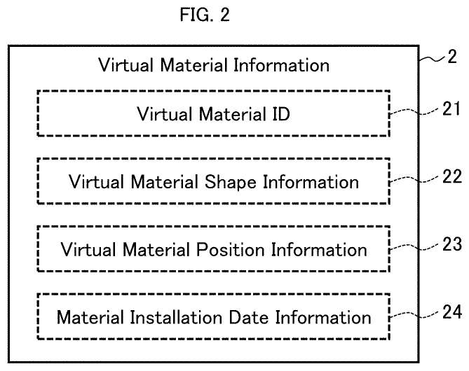

FIG. 2 shows an example of the virtual material information. The virtual material information 2 according to the present example includes the virtual material ID 21, the virtual material shape information 22, the virtual material position information 23, and the material installation date information 24.

The virtual material ID 21 is information for identifying individual virtual materials. The virtual material ID 21 indicates the types of virtual materials (e.g., column, beam, wall, slab, roof, foundation, window, door, stair, tile, flooring, part, machine, device, equipment, facility, or the like). The virtual material ID 21 may be, for example, identification information given to each physical material (material number or the like). The virtual material ID 21 is acquired from BIM data, a design specification, a construction drawing, a working drawing, a working diagram, a construction document, or the like, for example. Further, the virtual material ID 21 may be individually unique identification information. Examples of such virtual material ID 21 include identification information provided in conformity with the Industry Foundation Classes (IFC), which is a file format of a neutral and open CAD data model.

The virtual material shape information 22 is information representing the shape of a virtual material. The virtual material shape information 22 may also include information representing the orientation, direction, posture, or the like of a virtual material. The virtual material shape information 22 is acquired from BIM data, a design specification, a construction drawing, a working drawing, a working diagram, a construction document, or the like, for example.

The virtual material position information 23 represents the position of a virtual material of a virtual building. The position of a virtual material is represented by, for example, the coordinates of the virtual material in the virtual space (three dimensional virtual space defined by a three dimensional coordinate system) in which the virtual building is defined and designed. The virtual material position information 23 is acquired from BIM data, a design specification, a construction drawing, a working drawing, a working diagram, a construction document, or the like, for example.

The material installation date information 24 indicates the date on which the physical material corresponding to a virtual material is installed at the building site or the construction site (e.g., actual installation date, scheduled installation date, or the like). The material installation date information 24 is obtained from a construction drawing, a working drawing, a working diagram, a construction document, or the like, for example.

The system 1 (e.g., the controller 11 and the memory 14) provides, for example, a design database for managing the design data 141. For example, the design database stores data of a virtual building (a plurality of virtual materials of the virtual building) designed using a BIM application. The design database is configured to manage a plurality of virtual materials included in the virtual building one by one. For example, the design database stores the design data 141 including actual BIM data. The design database may be configured to manage the design data 141 for individual virtual buildings, for example.

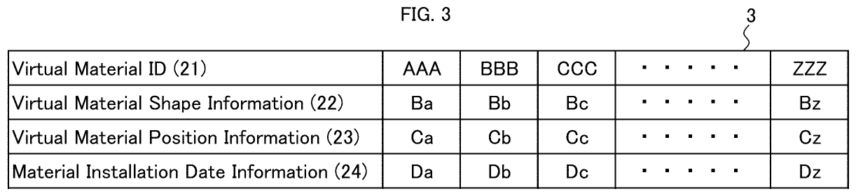

FIG. 3 shows an example of the data structure (data format) of the virtual material information 2 (see FIG. 2) under the management of the design database. The data structure 3 of the present example manages the virtual material information 2 using a table. To be more specific, the table of the data structure 3 may include a virtual material ID section, a virtual material shape information section, a virtual material position information section, and a material installation date information section. The virtual material ID section contains a plurality of cells (or fields) in each of which virtual material ID is entered and recorded. The virtual material shape information section contains a plurality of cells in each of which virtual material shape information is entered and recorded. The virtual material position information section contains a plurality of cells in each of which virtual material position information is entered and recorded. The material installation date information section contains a plurality of cells in each of which material installation date information is entered and recorded. For example, given that a certain virtual material has the virtual material ID 21 “BBB”, the virtual material shape information 22 “Bb”, the virtual material position information 23 “Cb”, and the material installation date information 24 “Da” are being associated with the virtual material ID 21 “BBB” by the data structure 3.

The physical material data 142 may be any type of data and/or any type of information relating to physical materials. The physical material data 142 may be generated based on measured data obtained by measuring a physical building constructed on the basis of the design data 141, for example. Here, the physical building measurement may be conducted by photographing or laser scanning, and the measured data may be a photographed image or point cloud data. The physical building measurement can be performed by the data acquiring unit 13 or an external system. The generation of the physical material data 142 based on the measured data can be executed by the data acquiring unit 13 or an external system. The physical material data 142 may be generated and managed as BIM data in conformity with the same format as the design data 141, for example.

The physical material data 142 includes information on a plurality of physical materials that are structural elements or components of a physical building. More specifically, the physical material data 142 includes information relating to a plurality of attributes set in advance for each of the plurality of the physical materials. The attributes here mean properties, features, characteristics and the like of physical materials.

In some aspect examples, the plurality of attributes of the physical material corresponds to the plurality of attributes of the virtual material described above. For example, the plurality of attributes of the physical material includes physical material identification information (physical material ID), physical material shape information, physical material position information, measurement date information, and the like. It should be noted that the attributes of the physical materials are not limited to these items, and may be any types of property, feature, or characteristic such as a raw material, an ingredient, a constituent, a substance, or the like.

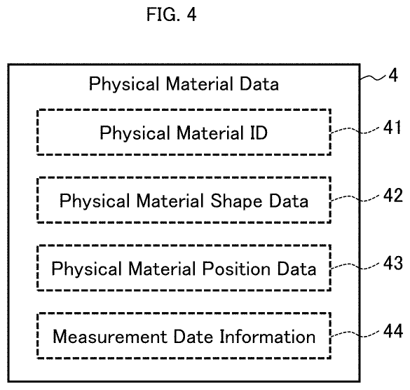

FIG. 4 shows an example of the physical material data. The physical material data 4 according to the present example includes the physical material ID 41, the physical material shape data 42, the physical material position data 43, and the measurement date information 44.

The physical material ID 41 is information for identifying individual physical materials. Similar to the virtual material ID 21, the physical material ID 41 is information indicating the types of physical materials, and may be, for example, identification information given to each physical material (material number or the like). In some aspect examples, identifiers in the physical material ID 41 may respectively be the same as corresponding identifiers in the virtual material ID 21, such as identification information provided by IFC. On the other hand, identifiers in the physical material ID 41 of some aspect examples may respectively be different from corresponding identifiers in the virtual material ID 21, and may be defined in conformity with a predetermined format in which the system 1 (and an external system or the like) is capable of recognizing the relationship between the virtual material ID 21 and the physical material ID 41. The physical material ID 41 is generated in the material associating process described later, for example.

The physical material shape data 42 is data representing the shape of a physical material acquired based on the measured data. The physical material shape data 42 may include data representing the orientation, direction, posture, or the like of a physical material. The physical material shape data 42 is generated in the material associating process described later, for example.

The physical material position data 43 represents the position of a physical material of a physical building. The position of a physical material is represented by, for example, the coordinates of the physical material in the virtual space (three dimensional virtual space defined by a three dimensional coordinate system) in which a BIM model of the physical building created based on the measured data is defined. The physical material position data 43 is generated in the material associating process described later, for example.

The measurement date information 44 indicates the date on which measurement of the physical building is conducted. The measurement date information 44 is generated, for example, by a measurement system (e.g., a mobile object, a total station, a computer, etc.) that performs physical building measurement.

The material installation date information 24 and the measurement date information 44 both include at least information of year, month, and day, and may further include information of hour, minute, second, or the like. The system 1 (or an external system, etc.) may be configured to perform the conversion for representing the material installation date information 24 and the measurement date information 44 in the same standard time in the case where the standard time of the place at which the building design is performed and the standard time of the place at which the physical building exists are different from each other.

The system 1 (e.g., the controller 11 and the memory 14) provides, for example, a physical material database for managing the physical material data 142. For example, the physical material database stores data of a BIM model of a physical building (a BIM model of a plurality of physical materials of the physical building) obtained by processing the measured data of the physical building. The physical material database is configured to manage a plurality of physical material models included in the physical building model one by one. For example, the physical material database stores a physical building BIM model. The physical material database may be configured to manage the physical material data 142 for individual physical building BIM models, for example.

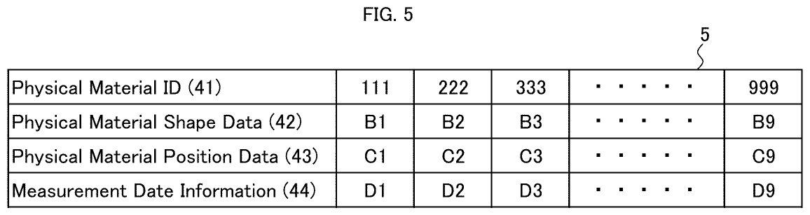

FIG. 5 shows an example of the data structure (data format) of the physical material data 4 (see FIG. 4) under the management of the physical material database. The data structure 5 of the present example manages the physical material data 4 using a table. To be more specific, the table of the data structure 5 may include a physical material ID section, a physical material shape data section, a physical material position data section, and a measurement date information section. The physical material ID section contains a plurality of cells (or fields) in each of which physical material ID is entered and recorded. The physical material shape data section contains a plurality of cells in each of which physical material shape data is entered and recorded. The physical material position data section contains a plurality of cells in each of which physical material position data is entered and recorded. The measurement date information section contains a plurality of cells in each of which measurement date information is entered and recorded. For example, given that a certain physical material has the physical material ID 41 “222”, the physical material shape data 42 “B2”, the physical material position data 43 “C2”, and the measurement date information 44 “D2” are being associated with the physical material ID 41 “222”.

The processor 15 is configured to execute data processing. The processor 15 is implemented, for example, by the cooperation of hardware including a processor and a storage device, and data processing software. The processor 15 may be included in a single computer or decentralized among two or more computers. The processor 15 includes the material associating processor 151 and the attribute associating processor 152.

The material associating processor 151 is configured to determine an association between the plurality of the virtual materials and the plurality of the physical materials based on the virtual material information and the physical material data included in the design data 141. The determination of the association is referred to as a material associating process. The material associating process generates a plurality of pairs of virtual and physical materials. The material associating processor 151 is implemented, for example, by the cooperation of hardware including a processor and a storage device, and material associating software.

An example will be described below of the processing executed by the material associating processor 151. First, the material associating processor 151 matches the coordinate space of the design data 141 and the coordinate space of the physical material data 142 with each other. For example, the material associating processor 151 matches the origin or a predetermined reference point in the coordinate space of the design data 141 and the origin or a predetermined reference point in the coordinate space of the physical material data 142 with each other. In other words, the material associating processor 151 performs registration between the design data 141 and the physical material data 142. The material associating processor 151 of some aspect examples performs registration to determine an association between the coordinate system with which the BIM data (virtual building model) in the design data 141 is defined and the coordinate system with which the BIM data (physical building model) in the physical material data 142 is defined. This enables coordinate conversion between the coordinate system representing the design data 141 and the coordinate system representing the physical material data 142.

Next, the material associating processor 151 performs determination of an association between an object in the design data 141 (e.g., the face, vertex, or center point of a virtual material) and an object in the physical material data 142. For example, the material associating processor 151 may be configured to associate a certain object in the design data 141 and a certain object in the physical material data 142 with each other if the distance between the two objects is less than or equal to a predetermined threshold. Accordingly, physical material position data of that object (physical material) is generated. The physical material position data 43 in FIG. 4 is an example of the physical material position data thus generated.

In addition, the material associating processor 151 may be capable of recognizing the shape of an object in the physical material data 142. For example, the material associating processor 151 may be configured to acquire data representing the shape of a column (surface shape, face shape, cross sectional shape, etc.), the shape of a beam, the shape of a wall, and the shape of a ceiling. Further, the material associating processor 151 may acquire data representing the arrangement (e.g., direction, orientation, posture, etc.) of an object in the physical material data 142. Furthermore, the material associating processor 151 may be configured to recognize the texture, material, raw material, ingredient, constituent, substance, or the like of the surface of an object. The recognized texture, material, raw material, ingredient, constituent, substance, or the like is used to generate the physical material shape data (e.g., the physical material shape data 42 in FIG. 4) of that object (physical material). The physical material shape data thus obtained may be used for improving the material associating process (e.g., improving the precision, improving the accuracy) on the basis of distance between objects.

In addition to the above, the material associating processor 151 assigns identification information (identifier) to each physical material identified from the physical material data 142. In other words, the material associating processor 151 may be configured to assign physical material IDs to the physical material data 142.

For example, the material associating processor 151 assigns, to a physical material associated with a certain virtual material, the same identification information as the virtual material ID of that virtual material. In this case, the same identification information is assigned to the pair of the virtual material and the physical material associated with each other. That is, the virtual material and the physical material associated with each other are linked by the same identification information. The identification information commonly assigned to both the virtual material and the physical material may be, for example, unique identification information in conformity with IFC.

In another example, the material associating processor 151 may be configured to assign, to a physical material associated with a certain virtual material, identification information similar to the virtual material ID of that virtual material. For example, a physical material ID consisting of a character string that includes at least part of the character string constituting the virtual material ID of that virtual material, is assigned to the physical material.

In yet another example, the material associating processor 151 may be configured to assign, to a physical material associated with a certain virtual material, unique identification information (physical material ID) and also record the virtual material ID of the virtual material in an additional recording region in the physical material data.

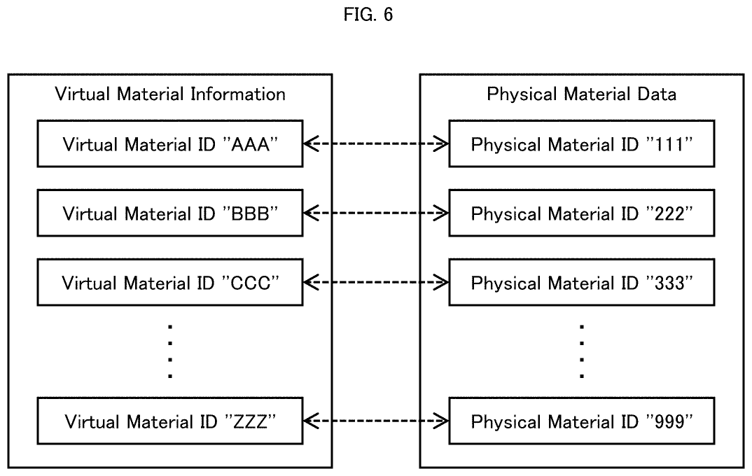

Such a material associating process can establish a correspondence relationship between a plurality of virtual materials and a plurality of physical materials. In other words, a plurality of pairs (material pairs) of the virtual material and the physical material can be obtained by the material associating process. For example, as shown in FIG. 6, the correspondence relationship may be obtained between the plurality of pieces of the identification information of a plurality of virtual materials (virtual material IDs) in the data structure 3 of FIG. 3 and the plurality of pieces of the identification information of a plurality of physical materials (physical material IDs) in the data structure 5 of FIG. 5.

Note that while the correspondence relationship shown in FIG. 6 is a bijection between the set consisting of the plurality of the virtual materials and the set consisting of the plurality of the physical materials, examples of such a correspondence relationship are not limited to a bijection. For example, if there is no physical material in the vicinity of a certain virtual material, that is, if there is no physical material within a range or area of a predetermined distance or less from that virtual material, then there is no physical material to be associated with that virtual material. Conversely, if there is no virtual material in the vicinity of a certain physical material, that is, if there is no virtual material within a range or area of a predetermined distance or less from that physical material, then there is no virtual material to be associated with that physical material. In some aspect examples, if there are two or more physical materials in the vicinity of a certain virtual material, then at least one or more of the two or more physical materials may be associated with that single virtual material. Conversely, if there are two or more virtual materials in the vicinity of a certain physical material, then at least one or more of the two or more virtual materials may be associated with that single physical material. In the case where a correspondence relationship (or a function) other than a bijective function is obtained as in the above example cases, the controller 11 may display the obtained correspondence relationship on the user interface 12, for example. Then, the user may edit the correspondence relationship using the user interface 12.

The attribute associating processor 152 is configured to associate virtual material information and physical material data with each other according to a plurality of attributes, for a material pair (that is, a pair of a virtual material and a physical material) obtained by the material associating processor 151. The attribute associating processor 152 is implemented, for example, by the cooperation of hardware including a processor and a storage device, and attribute associating software.

In some aspect examples, the plurality of attributes of a virtual material may be the same as the plurality of attributes of a physical material, for the paired virtual and physical materials. In some aspect examples, the plurality of attributes of a physical material may include all of the plurality of attributes of a virtual material, for the paired virtual and physical materials. For example, a metadata structure may be prepared in advance in which common attributes can be registered for virtual material information and physical material data. The attribute associating processor 152 may be configured to utilize the metadata structure to determine an association between the attributes of a virtual material and the attributes of a physical material.

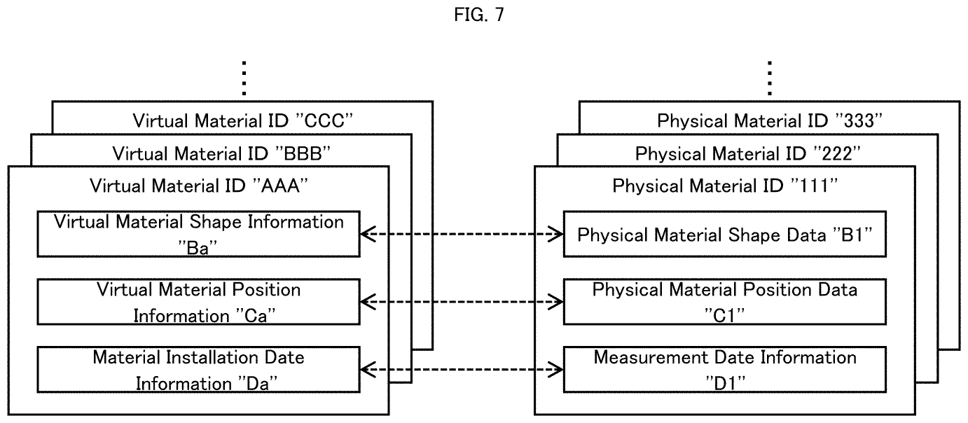

For example, the correspondence relationship is obtained, as shown in FIG. 7, between the plurality of attributes of each virtual material (each virtual material ID) in the data structure 3 of FIG. 3 and the plurality of attributes of each physical material (each physical material ID) in the data structure 5 of FIG. 5. In the present example, the following associations are determined for the pair of the virtual material with the virtual material ID “AAA” and the physical material with the physical material ID “111” , for example: the association between the virtual material shape information “Ba” and the physical material shape data “B1”; the association between the virtual material position information “Ca” and the physical material position data “Cl”; and the association between the material installation date information “Da” and the measurement date information “Dl”. The same applies to other material pairs.

As described above, the system 1 according to the present aspect example is a system used for photogrammetry of a building, and includes the memory 14, the material associating processor 151, and the attribute associating processor 152. The memory 14 records design data that includes virtual material information relating to a plurality of attributes for each of a plurality of virtual materials of a virtual building. Further, the memory 14 records physical material data relating to a plurality of attributes for each of a plurality of physical materials, in which the physical material data is generated based on measured data acquired by measurement of a physical building constructed on the basis of the design data. The material associating processor 151 is configured to perform determination of an association between the plurality of the virtual materials and the plurality of the physical materials based on the virtual material information and the physical material data, thereby generating a plurality of pairs of virtual and physical materials. The attribute associating processor 152 is configured to perform determination of an association between the virtual material information and the physical material data in accordance with the plurality of the attributes, for each of the plurality of pairs generated by the material associating processor 151.

The present aspect example also provides a structure of data (data structure) to be processed by a building photogrammetry system. The data structure includes design data and physical material data. The design data is prepared in advance and includes virtual material information on a plurality of attributes for each of a plurality of virtual materials of a virtual building. The physical material data is generated based on measured data acquired by measurement of a physical building constructed on the basis of the design data, and includes data on the plurality of the attributes for each of a plurality of physical materials of the physical building. The design data and the physical material data are used for a material associating process and an attribute associating process. The material associating process is a process of determining an association between the plurality of the virtual materials and the plurality of the physical materials based on the virtual material information and the physical material data. The attribute associating process is a process of determining an association between the virtual material information and the physical material data in accordance with the plurality of the attributes, for each of a plurality of pairs of virtual and physical materials established by the material associating process. In addition, the present aspect example is capable of providing a computer-readable non-transitory recording medium in which data having the structure described above is recorded. The non-transitory recording medium may be any of a magnetic disk, an optical disk, a magneto-optical disk, and a semiconductor memory, for example.

In addition, the virtual material information 2 of the system 1 of the present aspect example may include the virtual material position information 23 and the physical material data 4 may include the physical material position data 43. If this is the case, the material associating processor 151 may be configured to generate a plurality of pairs of a virtual material and a physical material based on the virtual material position information 23 and the physical material position data 43.

This configuration example provides a data structure having the following characteristics or features: the virtual material information 2 includes the virtual material position information 23; the physical material data 4 includes the physical material position data 43; and the virtual material position information 23 and the physical material position data 43 are used for the material associating process.

Further, the virtual material information 2 of the system 1 of the present aspect example may include the material installation date information 24 indicating the installation date for each of the plurality of the virtual materials, and the physical material data 4 may include the measurement date information 44 indicating the measurement date of the physical building. Further, the material associating processor 151 may be configured to generate a plurality of pairs of a virtual material and a physical material based on the material installation date information 24 and the measurement date information 44.

This configuration example provides a data structure that has the following characteristics or features: the virtual material information 2 includes the material installation date information 24 indicating the installation date for each of the plurality of the virtual materials; the physical material data 4 includes the measurement date information 44 indicating the measurement date of the physical building; and the material installation date information 24 and the measurement date information 44 are used for the material associating process.

In the case of using the material installation date information 24 and the measurement date information 44, the association may be performed between a plurality of pieces of virtual material information corresponding to a plurality of different installation dates and a plurality of pieces of physical material data corresponding to a plurality of different measurement dates, by checking the material installation dates and the measurement dates against each other. For example, for a certain installation date, the material associating processor 151 may select a measurement date closest to this installation date from among one or more measurement dates after this installation date. Then, the material associating processor 151 may associate physical material data corresponding to the selected measurement date with the virtual material information corresponding to this installation date. As a result of this, a virtual material (virtual material information) and a physical material (physical material data) can be associated with each other based on dates. Accordingly, it becomes to be able to implement time series data management according to a construction document, a construction plan, a construction schedule, or the like, for example.

Further, the present aspect example provides a program for causing a computer, which is included in a building photogrammetry system, to function as a data receiving means, a material associating means, and an attribute associating means. The data receiving means (e.g., the data acquiring unit 13) receives design data and physical material data. The design data includes virtual material information that relates to a plurality of attributes for each of a plurality of virtual materials of a virtual building. The physical material data is generated based on measured data obtained by measurement of a physical building constructed on the basis of the design data, and relates to a plurality of attributes for each of a plurality of physical materials of the physical building. The material associating means (e.g., the material associating processor 151) performs determination of an association between the plurality of the virtual materials and the plurality of the physical materials, based on virtual material information and physical material data. The attribute associating means (e.g., the attribute associating processor 152) performs determination of an association between virtual material information and physical material data according to a plurality of attributes for each of a plurality of pairs of a virtual material and a physical material established by the material associating means. In addition to this, the present aspect example may provide a computer-readable non-transitory recording medium in which such a program is recorded. The non-transitory recording medium may be, for example, any of a magnetic disk, an optical disk, a magneto-optical disk, and a semiconductor memory.

According to the present aspect example as described above, design data of a building and data of a building constructed based on the design data can be associated with each other on a material-by-material basis (or as a series of material-by-material basis) as well as on a material-attribute-by-material-attribute basis.

The virtual material information is information used for facilitation of measurement works and operations of a physical building, and the physical material data is data obtained by the building measurement using the virtual material information. Such determination of the associating of the virtual material information and the physical material data on the material basis as well as on the attribute basis makes it easy to compare the design data and the actually measured data with each other. For example, comparison between design BIM data and measurement BIM data can be facilitated. Here, the design BIM data is BIM data as design data, and the measurement BIM data is BIM data created based on measured data.

In this way, the present aspect example makes it possible to integrate the managements of various types of data and information, which makes it possible to improve the efficiency and the consistency of the managements.

### SECOND ASPECT EXAMPLE

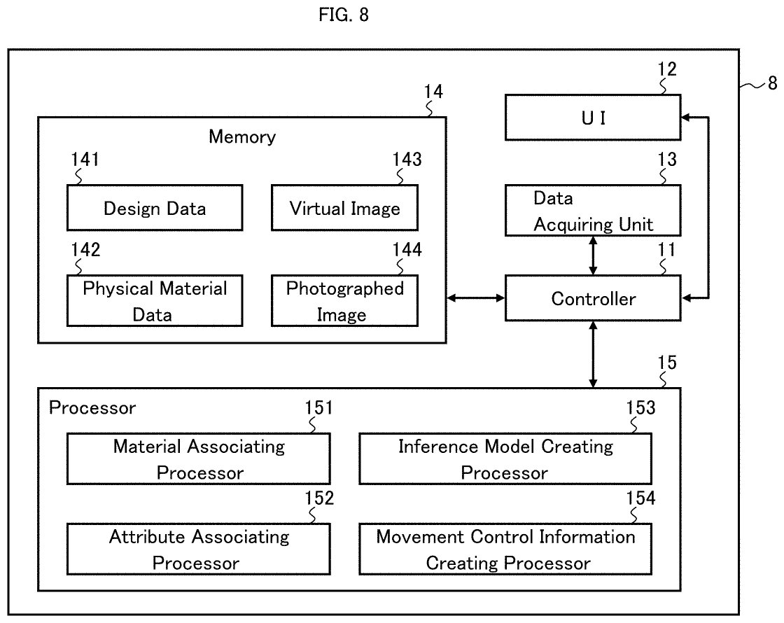

FIG. 8 shows a configuration example of the system according to the second aspect example. The system 8 has a configuration obtained by adding the inference model creating processor 153 and the movement control information creating processor 154 to the processor 15 of the system 1 of the first aspect example. The inference model creating processor 153 is implemented, for example, by the cooperation of hardware including a processor and a storage device, and inference model creating software. Further, the movement control information creating processor 154 is implemented, for example, by the cooperation of hardware including a processor and a storage device, and movement control information creating software. Below, the description of the elements common to the first aspect example will be omitted unless otherwise mentioned.

The memory 14 of the present aspect example further records the virtual image 143 and the photographed image 144 in addition to the design data 141 and the physical material data 142. The virtual image 143 is an image representing a virtual building, and is created by, for example, applying rendering to BIM data (CAD data). The virtual image 143 is, for example, a plurality of images (a virtual image set) representing the interior and/or the exterior of the virtual building along a movement route determined in advance. The photographed image 144 includes a photographed image of any object and a photographed image of a person. Examples of the photographed image of the object include an image of a building material, an image of a tool such as a ladder or a stepladder, and the like. Examples of the image of the person include an image of a worker at a building site or a construction site.

The inference model creating processor 153 is configured to create an inference model, which is used to identify an image of a building material from a photographed image of a building, by applying machine learning to a neural network. Examples of the applications of the inference model include the followings: control of a mobile object used to perform measurement (e.g., photographing, laser scanning) of a physical building; and creation of BIM data based on measured data (e.g., a photographed image, scan data) of a physical building.

The neural network employed for creating the inference model may include a convolutional neural network. For example, a convolutional neural network is configured to executed the following processes: receiving an input of an image; repeating generation of a feature map with a convolutional layer and compression of the feature map with a pooling layer a plurality of times; and providing a final output (e.g., image classification, segmentation, regression, etc.) with a fully connected layer that takes the output from the last pooling layer as input. Some aspect examples may employ a convolutional neural network including no fully connected layer, and some aspect examples may include a support vector machine.

Training data used for machine learning to create the inference model includes, for example, at least the virtual image 143, and may further include the photographed image 144. The training data may also include other measured data (such as scan data) of the physical building. In the present aspect example, utilizing the virtual image 143 created from the BIM data can reduce or eliminate the time and effort required for collecting a large amount of measured data of the physical building. In particular, the quality of machine learning and the quality of the inference model may be improved, by creating the virtual image 143 (the virtual image set) including a large number of images based on a large number of pieces of BIM data and by using the virtual images 143 thus created as training data for machine learning.

By using the photographed image 144, as training data, such as a photographed image of a building material, a photographed image of an object other than building materials, and a photographed image of a person, the inference model may be trained to detect tools and workers. Such machine learning makes it possible for a system to control the mobile object to avoid or dodge obstacles and workers. In addition, such machine learning makes it possible for a system to analyze measured data of a physical building to identify and exclude data corresponding to obstacles and data corresponding to workers when creating BIM data from the measured data.

The virtual image 143 and/or the measured data (e.g., the photographed image 144, scan data) included in the training data may include texture information indicating the state of the surface of a building material. By using the texture information, a final output that reflects the texture of the surface of an object may be obtained. This can thereby improve the quality of mobile object control and BIM data creation.

The training method employed for inference model construction may be optional. For example, the training method may be any of supervised learning, unsupervised learning, and reinforcement learning; or a combination of any two or more of them. Typically, supervised learning is conducted with training data in which a label as a final output is assigned to each input image.

The movement control information creating processor 154 is configured to create movement control information used for acquiring data of a building with a mobile object, based on the virtual image 143, or based on the virtual image 143 and the photographed image 144.

In the present aspect example, the movement control information creating processor 154 may create movement control information based on an inference model constructed on the basis of the virtual image 143 (and optionally the photographed image 144, etc.). The movement control information thus created may be provided to the mobile object, for example, through a wired network or a wireless network, or via a recording medium.

In some aspect examples, the movement control information creating processor may be configured to create movement control information by applying rule-based processing to the virtual image 143 (and optionally the photographed image 144, etc.), without using an inference model. The movement control information creating processor of some aspect examples may be configured to be capable of selectively applying processing with an inference model and rule-based processing.

The movement control information may include, for example, information on a movement route. The movement route is set in advance based on the design data 141 (BIM data), and used for measuring the interior of a physical building constructed based on the design data 141. The movement control information may also include virtual images (143) that are arranged along the movement route and constructed by applying rendering to the BIM data. In some aspect examples, the movement control information may include an inference model created by the inference model creating processor 153, that is, a neural network whose parameters (e.g., weights, weight coefficients, weighting factors) have been adjusted and tuned by the inference model creating processor 153.

The movement route may be set, for example, so that the distance to at least one or more of the plurality of the virtual materials recorded in the BIM data is included in a predetermined allowable range. This makes it possible to conduct photographing of a physical material in the physical building from a suitable distance. Further, the movement route may be any of a one dimensional area, a two dimensional area, and a three dimensional area. A two dimensional area or a three dimensional area as the movement route represents, for example, an area in which a mobile object, which is performing measurement while moving, is able to move in order to avoid or dodge obstacles.

The operation to avoid a collision with an obstacle is not limited to dodging, taking a detour, or taking a roundabout route. For example, the mobile object of some aspect examples may be controlled and operated to stop moving when an obstacle is detected. Further, the mobile object of some aspect examples may be controlled and operated to output auditory information or visual information when an obstacle is detected. An example of the auditory information is warning sound, and an example of the visual information is warning light. In addition, some aspect examples may be configured to conduct control of causing a device for operating the mobile object (e.g., a tablet, a smartphone, or a laptop computer) to output auditory information and/or visual information in response to detection of an obstacle.

The system 8 of the present aspect example provides a data structure that has the following characteristics or features in addition to those of the data structure of the first aspect example: the data structure of the present aspect example further includes the virtual image 143 of the virtual building generated in advance; and the virtual image 143 is used for creation of movement control information that is used for acquiring data of a building with a mobile object.

The system 8 of the present aspect example also provides a data structure further having the following characteristics or features: the data structure of the present aspect example further includes the photographed image 144 acquired in advance; and the photographed image 144 is used for the creation of the movement control information.

Furthermore, the system 8 of the present aspect example provides a data structure further having the following characteristics or features: the data structure of the present aspect example further includes an inference model that is created by applying machine learning with at least the virtual image 143 to a neural network and that is used for identifying an image of a building material from a photographed image of a building; and the inference model is used for the creation of the movement control information.

In addition, the present aspect example may provide a computer-readable non-transitory recording medium in which any of the data having the data structure provided by the system 8. The same applies to a program, and also a computer-readable non-transitory recording medium that records this program.

As in the first aspect example, the present aspect example makes it possible to integrate the managements of various types of data and information, and improve the efficiency and the consistency of the managements. In addition, the present aspect example is capable of creating movement control information based on the virtual image 143 (and based optionally on the photographed image 144), thereby making it possible to furnish support for building measurement using a mobile object (e.g., a UAV, an autonomous vehicle, a person, etc.). The present aspect example also makes it possible to save the labor of measurement works and shorten measurement time.

### THIRD ASPECT EXAMPLE

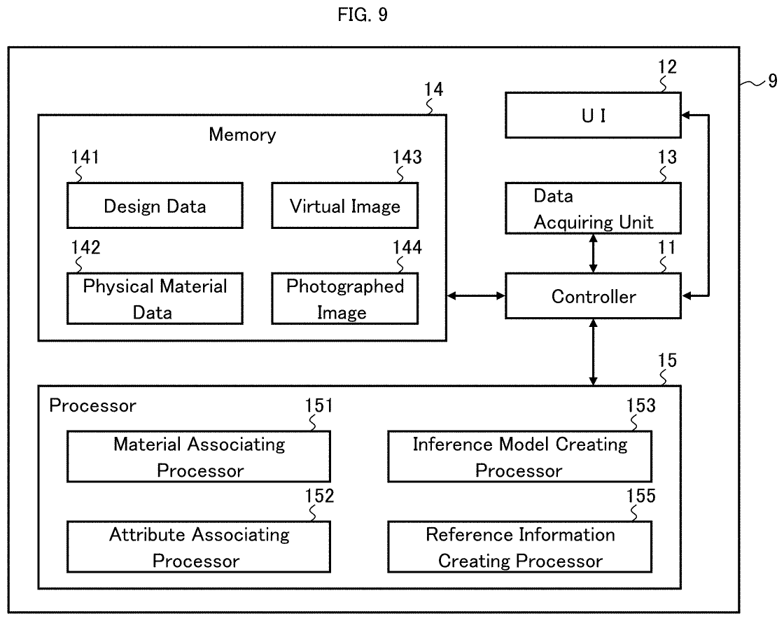

FIG. 9 shows a configuration example of the system according to the third aspect example. The system 9 includes the reference information creating processor 155 in place of the movement control information creating processor 154 of the processor 15 of the system 8 of the second aspect example. The inference model creating processor 153 is implemented, for example, by the cooperation of hardware including a processor and a storage device, and inference model creating software. Further, the reference information creating processor 155 is implemented, for example, by the cooperation of hardware including a processor and a storage device, and reference information creating software. Below, the description of the elements common to the second aspect example will be omitted unless otherwise mentioned.

The reference information creating processor 155 is configured to create, based on the virtual image 143 (and optionally the photographed image 144), reference information used for determining whether data of a building material is acquired in parallel with acquiring data of a building with a mobile object. The reference information creating processor 155 of the present aspect example may create reference information based on the inference model constructed by the inference model creating processor 153. The reference information created is provided to the mobile object, for example, through a wired or wireless network, or via a recording medium.

In some aspect examples, the reference information creating processor may be configured to create reference information by applying rule-based processing to the virtual image 143 (and optionally the photographed image 144, etc.) without using an inference model. In some aspect examples, the reference information creating processor may be configured to be capable of selectively applying processing with an inference model and rule-based processing.

As mentioned above, the reference information is used to determine whether data of a building material (physical material) of a physical building have been acquired in parallel with performing measurement of the physical building using a mobile object. In other words, the reference information is used to determine whether measured data of a physical material, which is the target data of the measurement with a mobile object, has been acquired for certain.

The reference information may include information on a movement route. The movement route is set in advance on the basis of the design data 141 (e.g., BIM data, virtual material information, etc.), and is used for measuring the interior of a physical building, for example. In some aspect examples, the reference information may include the virtual image 143. Further, in some aspect examples, the reference information may include an inference model created by the inference model creating processor 153.

The mobile object may be configured to perform the following processes, for example: a process of creating a map (e.g., a three dimensional model) of the area around the mobile object (the environment of the mobile object) from a photographed image using V-SLAM; a process of detecting a material (material model, material data, or the like) from the three dimensional model using an inference model; a process of checking the detected material against the design data141 (BIM data, virtual material information, etc.); and a process of determining whether or not measured data of a physical material has been obtained based on the result of the check against the design data141. The mobile object may be configured to output auditory information and/or visual information indicating a result of the determination. Further, a device used for operating the mobile object may be configured to output auditory information and/or visual information indicating a result of the determination.

The system 9 of the present aspect example provides a data structure that has the following characteristics or features in addition to those of the data structure of the first aspect example: the data structure of the present aspect example further includes the virtual image 143 of a virtual building generated in advance; and the virtual image 143 is used to create reference information that is used for determining whether data of a building material has been acquired in parallel with acquiring data of a building with a mobile object.

The system 9 of the present aspect example also provides a data structure that further has the following characteristics or features: the data structure of the present aspect example further includes the photographed image 144 acquired in advance; and the photographed image 144 is used to create reference information.

The system 9 of the present aspect example also provides a data structure that further has the following characteristics or features: the data structure of the present aspect example further includes an inference model that is created by applying machine learning with at least the virtual image 143 to a neural network, and that is used to identify an image of a building material from a photographed image of a building; and the inference model is used to create reference information.

In addition, a computer-readable non-transitory recording medium may be created in which the data having a structure provided by the system 9 of the present aspect example is recorded. The same applies to a program and a computer-readable non-transitory recording medium that records the program.

As in the first aspect example, the present aspect example makes it possible to integrate the managements of various types of data and information, and improve the efficiency and the consistency of the managements. Furthermore, the present aspect example can create reference information based on the virtual image 143 (and optionally the photographed image 144), thereby making it possible to conduct real time determination of whether building measurement with a mobile object (e.g., a UAV, an autonomous vehicle, a person, etc.) is being properly performed. If the measurement is not being performed properly, at least part of the measurement can be performed again. As a result of this, for example, a situation can be avoided in which meaningless or useless measured data is provided to a subsequent stage of processing. In addition, since the present aspect example can automate the determination of whether or not remeasurement is necessary, it becomes possible to save the labor of measuring and shorten the measurement time.

### FOURTH ASPECT EXAMPLE

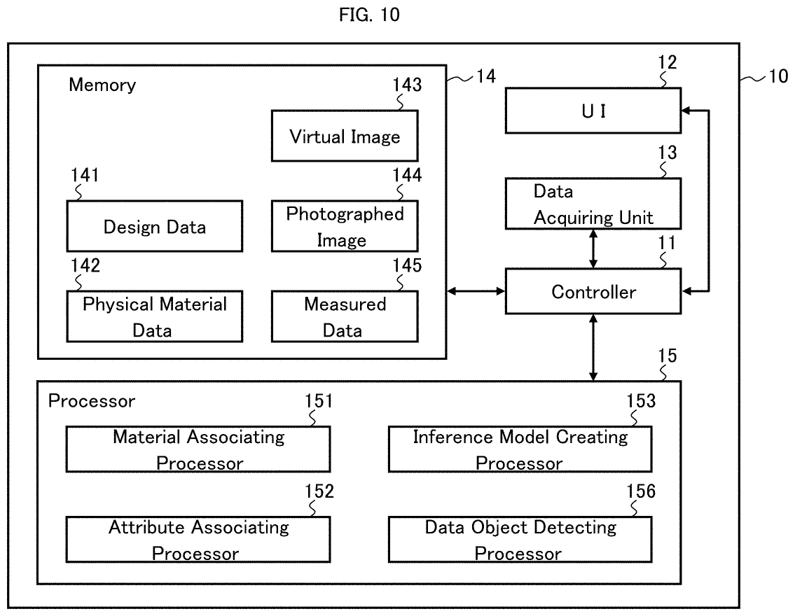

FIG. 10 shows a configuration example of the system according to the fourth aspect example. The system 10 includes the data object detecting processor 156 in place of the movement control information creating processor 154 of the processor 15 of the system 8 of the second aspect example, and further stores the measured data 145 in the memory 14. The inference model creating processor 153 is implemented, for example, by the cooperation of hardware including a processor and a storage device, and inference model creating software. Further, the data object detecting processor 156 is implemented, for example, by the cooperation of hardware including a processor and a storage device, and data object detecting software. Below, the description of the elements common to the second aspect example will be omitted unless otherwise mentioned.

The measured data 145 is data acquired by actually conducting measurement of a building, and is a photographed image or scan data, for example. The measured data 145 is acquired, for example, by photographing or performing a laser scan while moving along a predetermined route within a building.

The data object detecting processor 156 is configured to detect a data object from the measured data 145 based on the virtual image 143 (and optionally the photographed image 144). In the case where the measured data 145 is a photographed image, a data object is an image object depicted in the photographed image, and is typically an image of a building material (physical material). In the case where the measured data 145 is scan data, a data object is a data region in the scan data, and is typically partial data corresponding to a building material (physical material).

The data object detecting processor 156 of the present aspect example may detect a data object from the measured data 145 based on the inference model created by the inference model creating processor 153. In some aspect examples, the data object detecting processor may be configured to detect a data object by applying rule-based processing to the measured data 145 without using an inference model. In some aspect examples, the data object detecting processor may be configured to be capable of selectively applying processing using an inference model and rule-based processing.

A description will now be given of an example of the processing executed by the data object detecting processor 156. The data object detecting processor 156 first determines a plurality of positions and orientations (postures, directions) of a measuring instrument or a measuring device (e.g., a camera, a laser scanner) by applying structure from motion (SfM) to the measured data 145, and then reconstructs the shape of an object in the environment depicted (rendered, recorded) in the measured data 145.

In some aspect examples, the data object detecting processor 156 identifies a data object corresponding to a building material from the measured data 145 by inputting the measured data 145 into the inference model. As a result of this, a plurality of data objects included in the measured data 145 are recognized or detected, and the attributes of the material corresponding to each data object are identified.

Subsequently, the data object detecting processor 156 applies a mask to the external region of the data object identified, detects a feature point of the data object, and determines a three dimensional position (three dimensional coordinates) of the detected feature point by multi-view stereo (MVS).

The processor 15 may compare the three dimensional coordinate data of the building material obtained by the data object detecting processor 156 with the design data 141 (BIM data). For example, the processor 15 first performs registration, in a common three dimensional coordinate system, between the three dimensional coordinate data obtained by the data object detecting processor 156 and the coordinate information of the face data (or point data, point cloud data, etc.) in the BIM data. Next, the processor 15 selects, from the three dimensional coordinate data, a three dimensional coordinate point located in the vicinity of a predetermined face data in the BIM data. Subsequently, the processor 15 defines a face (e.g., a plane, a freeform surface) in the three dimensional coordinate data using the three dimensional coordinate point selected. Then, the face defined is associated with the above predetermined face data in the BIM data. Such a series of processes can establish a correspondence relationship between a plurality of faces represented in the BIM data and a plurality of faces of the building constructed based on the BIM data. Typically, such a series of processes makes it possible to establish a correspondence relationship between the surfaces of virtual materials and the surfaces of physical materials.

The processor 15 may be configured to create new BIM data by using any of the three dimensional coordinate data, the face data, and the correspondence relationships thus obtained. For example, the processor 15 may be configured to change the BIM data of the design data 141 by using the data obtained from the measured data 145. For example, the processor 15 compares the position of the face of a column in the BIM data and the position of the face of an actual column determined from the measured data 145 with each other, and then replaces the virtual position in the BIM data with the actual position. As a consequence, new BIM data that reflects the position of the actual column (e.g., direction, shape, orientation, etc.) can be obtained. In this series of processes, the material associating processor 151 may perform determination of an association between the virtual materials in the BIM data of the design data 141 and the physical materials in the physical material data 142, using a data object (e.g., three dimensional coordinate data, face data, a correspondence relationship, etc.) detected by the data object detecting processor 156.

The data object detected by the data object detecting processor 156 is not limited to building materials. For example, the data object detecting processor 156 may be configured to detect an obstacle as a data object. In the case where an obstacle has been detected as a data object, the BIM data may be edited by excluding the data object corresponding to the obstacle. This makes it possible to avoid confusing an obstacle in the measured data 145 with a building material, which makes it possible to improve the BIM data editing.

The system 10 of the present aspect example provides a data structure that has the following characteristics or features in addition to those of the data structure of the first aspect example: the data structure of the present aspect example further includes the virtual image 143 of a virtual building generated in advance and the measured data 145 acquired in advance; the virtual image 143 is used for a data object detecting process that detects a data object from the measured data 145; and the data object detected by the data object detecting process is used for a material associating process.

The system 10 of the present aspect example also provides a data structure that further has the following characteristics or features: the data structure of the present aspect example further includes the photographed image 144 acquired in advance; and the photographed image 144 is used for a data object detecting process.

The system 10 of the present aspect example also provides a data structure that further has the following characteristics or features: the data structure of the present aspect example further includes an inference model that is created by applying machine learning with at least the virtual image 143 to a neural network, and that is used to identify an image of a building material from a photographed image of a building; and the inference model is used for a data object detecting process.

In addition, a computer-readable non-transitory recording medium that records the data having a structure provided by the system 10 of the present aspect example can be created. The same applies to a program and a computer-readable non-transitory recording medium that records the program.

As in the first aspect example, the present aspect example makes it possible to integrate the managements of various types of data and information, and improve the efficiency and the consistency of the managements. In addition, the creation of new BIM data can be automated because the present aspect example can detect a data object from data of a building based on the virtual image 143 (and optionally the photographed image 144), and generate a plurality of material pairs (pairs of virtual and physical materials) by executing a material associating process based on the data object detected. The automation of the new BIM data creation processing can facilitate the acquisition of BIM data that reflects the construction status or condition. The automation can also facilitate the accumulation and/or the update of BIM data according to the construction status or condition. In this way, the present aspect example contributes to the measuring labor saving and shortening of the measurement time.

### FIFTH ASPECT EXAMPLE

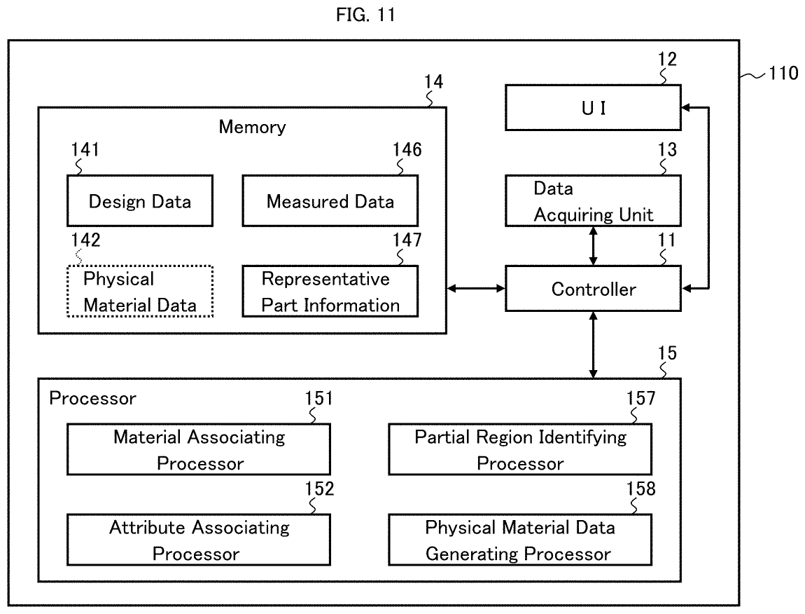

A building is composed of many building materials. Creating a three dimensional model for every building material is desirable from the viewpoint of data detail and accuracy; however, it is not realistic considering the resources and loads required for processing. Such a problem has been touched upon in the fourth aspect example. The fifth aspect example here provides a technique or technology to address this problem. FIG. 11 shows a configuration example of the system according to the present aspect example.

The system 110 is obtained by adding the partial region identifying processor 157 and the physical material data generating processor 158 to the processor 15 of the system 1 of the first aspect example, and further stores the measured data 146 and the representative part information 147 in the memory 14. The partial region identifying processor 157 is implemented, for example, by the cooperation of hardware including a processor and a storage device, and partial region identifying software. Further, the physical material data generating processor 158 is implemented, for example, by the cooperation of hardware including a processor and a storage device, and physical material data generating software. Below, the description of the elements common to the first aspect example will be omitted unless otherwise mentioned.

The system 110 is configured to generate the physical material data 142 from the measured data 146, and therefore it is not required that the physical material data 142 is stored in the memory 14 at the stage when the system 110 starts processing. However, the physical material data 142 generated in the past may be stored in the memory 14 at the stage when the system 110 starts processing.

The measured data 146 is data obtained by measuring a physical building constructed based on the design data 141 (BIM data) or the like, and is, for example, a photographed image or scan data. The measured data 146 is acquired, for example, by taking a photograph or performing a laser scan while moving along a route set in advance inside the physical building.

The representative part information 147 indicates a representative part of a virtual material recorded in the virtual material information of the design data 141. The representative part may be any part of the virtual material, and may be one or more points, one or more lines, or one or more faces, for example. The representative part may be the whole of the virtual material; however, taking a purpose of the present aspect example into account, which is the reduction of the processing resources and the processing loads, setting the representative part to the whole of a virtual material for every virtual material recorded in the virtual material information is not pertinent. Therefore, the present aspect example may assume that the representative part of at least one of the plurality of the virtual materials recorded in the virtual material information is not the whole of that virtual material.

Some examples of the representative part information147 are described below. If the building material of interest is a column with a rectangular horizontal cross section, the representative part of the column may be any one or more of the following, for example: any one or more of the four side faces, the center point of the bottom face, and the center point of the top face. If the representative part of the column includes two or more side faces, information (i.e., identifier(s)) may be employed that makes the two or more side faces mutually identifiable.

If the building material of interest is a floor, the representative part of the floor may be its upper face (the top face). Similarly, if the building material of interest is a ceiling, the representative part of the ceiling may be its bottom face.

For other building materials, for example, any of the following may be employed as a respective representative part so that measurement and data processing can be properly performed: any one or more points, any one or more lines, and any one or more faces. Further, in the case where two or more representative parts are set for a single building material, identification information is assigned to each of the two or more representative parts. The two or more pieces of identification information respectively assigned to the representative parts are referred to, in data processing, in order to differentiate the representative parts.

The partial region identifying processor 157 is configured to identify, based on the representative part information 147, a partial region of the measured data 146 corresponding to the representative part of any of the plurality of the virtual materials constituting the virtual building.

To do so, the partial region identifying processor 157 first identifies a data region of the measured data 146 corresponding to a virtual material of interest. In other words, the partial region identifying processor 157 identifies, from the measured data 146, a data region representing a physical material corresponding to a virtual material of interest. This process may be performed using SfM and an inference model, as in the data object detecting processor 156 of the fourth aspect example, for example. By executing this process for each virtual material, a plurality of data regions (a plurality of physical material regions) respectively corresponding to a plurality of physical materials are identified from the measured data 146. Note that rule-based image processing may be employed in place of an inference model.

Subsequently, for each virtual material, the partial region identifying processor 157 identifies a partial region corresponding to the representative part of the virtual material from the physical material region corresponding to the virtual material. Here, MVS may be used to determine the three dimensional coordinates of measurement points in the measured data 146. For example, MVS may be used to determine the three dimensional coordinates of the physical material region in the measured data 146 and to determine the three dimensional coordinates of a partial region in the physical material region.

If the representative part of the virtual material of interest is a point, the partial region identifying processor 157 may, for example, calculate the distance between the representative part (the above point) and each measurement point in the measured data 146. Then, the partial region identifying processor 157 may identify a partial region corresponding to the representative part (the above point) by applying thresholding to the distance calculated.

If the representative part of the virtual material of interest is a face (at least part of the surface of the virtual material), the partial region identifying processor 157 may determine, for example, for each measurement point in the measured data 146, a straight line (perpendicular line) that passes through the measurement point and is orthogonal to the representative part (the above face). Then, the partial region identifying processor 157 may calculate the distance between the measurement point and the foot of the perpendicular line, and identify a partial region corresponding to the representative part (the above face) by applying thresholding to the distance calculated. Also, in the case where the representative part of the virtual member of interest is a line, the partial region identifying processor 157 may identify a partial region in the measured data 146 corresponding to the representative part (the above line) in the same manner.

The physical material data generating processor 158 generates physical material data from the measured data 146 based on the partial region acquired by the partial region identifying processor 157. The physical material data generated is stored in the memory 14 as, for example, the physical material data 142 of the data structure shown in FIG. 5. In addition to this, the system 110 (e.g., the physical material data generating processor 158, the processor 15, or the controller 11) may assign the attributes shown in FIG. 4 (i.e., ID, shape, position, measurement date, etc.) to the physical material data generated.

The processor 15 can compare the three dimensional coordinates of the representative part of the physical material obtained by the partial region identifying processor 157 and the three dimensional coordinates of the representative part of the corresponding virtual material (e.g., the three dimensional coordinates in the design BIM data) with each other. For example, the processor 15 may determine the deviation of the representative part of the physical material with respect to the representative part of the virtual material. This deviation indicates the deviation (or shift) of the actual position from the position by design.

Furthermore, the processor 15 may make changes to the design BIM data based on the deviation of the representative position. For example, the processor 15 may change the position and/or the shape of a virtual material by replacing the three dimensional coordinates of the representative part of the virtual material with the three dimensional coordinates of the representative part of the corresponding physical material.

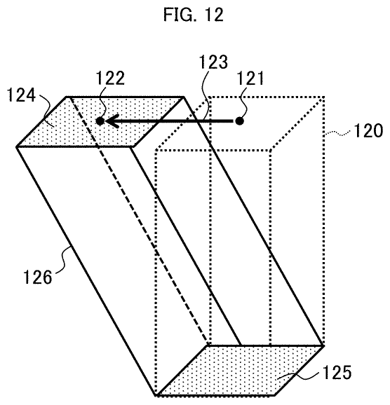

An example of design BIM data editing will be described with reference to FIG. 12. The reference character 120 denotes a column as a virtual material (referred to as a virtual column). The representative part of the virtual column 120 is set to the center of the upper face 121 (referred to as a virtual upper face center 121). The reference character 122 denotes the three dimensional coordinates in the measured data 146 corresponding to the virtual upper face center 121, which is identified by the partial region identifying processor 157. The three dimensional coordinates 122 is referred to as a physical upper face center 122. The reference character 123 denotes an arrow indicating the deviation of the physical upper face center 122 with respect to the virtual upper face center 121.

The processor 15 first determines the upper face region 124 whose center is the physical upper face center 122. In some aspect examples, the shape and the orientation of the upper face region 124 may be the same as the shape and the orientation of the upper face of the virtual column 120. Alternatively, in some aspect examples, the processor 15 may determine the upper face region 124 by varying at least one of the shape and the orientation of the upper face of the virtual column 120 according to the deviation 123.

Next, the processor 15 determines the line 126 connecting each of the vertices of the rectangular upper face region 124 and its corresponding vertex of the bottom face 125 of the virtual column 120. As a result of this, the four lines 126 each connecting the upper face region 124 and the bottom face 125 are obtained. Each line 126 may be a straight line, or may be a curved line corresponding to the deviation 123 (e.g., a freeform curve).

In this way, the position and the shape (e.g., direction, orientation, posture, etc.) of the virtual column 120 are changed based on the measured data 146. The changed information (e.g., the attributes) of the virtual column 120 is recorded as the physical material data 142 of the corresponding physical material (e.g., the column). The physical material data 142 thus obtained has the data structure shown in FIG. 5.

The system 110 of the present aspect example provides a data structure that has the following characteristics or features in addition to those of the data structure of the first aspect example: the data structure of the present aspect example further includes the measured data 146, and the representative part information 147 that indicates a representative part of a virtual material created in advance; and the representative part information 147 is used in the partial region identifying process that identifies a partial region of the measured data 146 corresponding to a representative part of a virtual material of a plurality of virtual materials of a virtual building.

The system 110 of the present aspect example also provides a data structure that further has the following characteristics or features: the partial region identified by the partial region identifying process is used in the process of generating the physical material data 142 from the measured data 146.

In addition, a computer-readable non-transitory recording medium that records the data having a structure provided by the system 110 of the present aspect example can be created. The same applies to a program and a computer-readable non-transitory recording medium that records the program.

According to the present aspect example, as in the first aspect example, it becomes possible to integrate the managements of various types of data and information, and improve the efficiency and the consistency of the managements.

Furthermore, the present aspect example is capable of identifying a partial region of the measured data corresponding to the representative part of the virtual material. Accordingly, the present aspect example is able to manage the data corresponding to the representative parts of the virtual materials instead of managing the three dimensional models of the physical materials. As a result of this, the resources required for management and processing can be reduced. For example, the efficiency of the process of generating the physical material data from the measured data can be improved.

### SIXTH ASPECT EXAMPLE

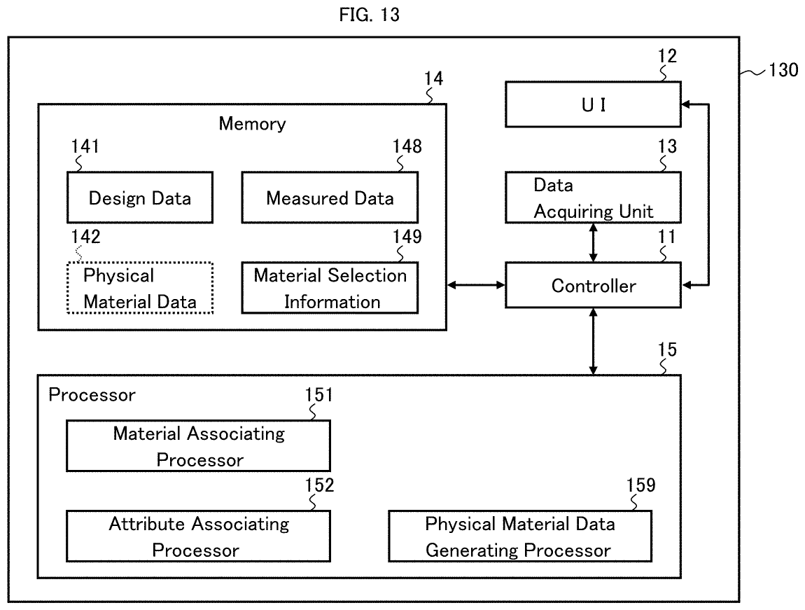

While a building is composed of many building materials as mentioned above, some materials may be considered as a group. For example, a group of columns may be considered together, and a column and a beam that are in contact with each other may be considered together. By collectively converting several materials into data, the efficiency of measurement and processing can be improved. The sixth aspect example will describe a technique or technology conceived and achieved from such a viewpoint. FIG. 13 shows a configuration example of the system according to the present aspect example.

The system 130 is obtained by adding the physical material data generating processor 159 to the processor 15 of the system 1 of the first aspect example, and further stores the measured data 148 and the material selection information 149 in the memory 14. The physical material data generating processor 159 is implemented, for example, by the cooperation of hardware including a processor and a storage device, and physical material data generating software. Below, the description of the elements common to the first aspect example will be omitted unless otherwise mentioned.

The system 130 is configured to generate the physical material data 142 from the measured data 148, and therefore it is not required that the physical material data 142 is stored in the memory 14 at the stage when the system 130 starts processing. On the other hand, the physical material data 142 generated in the past may be stored in the memory 14 at the stage when the system 130 starts processing.

The measured data 148 is data obtained by measurement of a physical building constructed based on the design data 141 (BIM data) or the like, and is a photographed image or scan data, for example. The measured data 148 is acquired, for example, by taking a photograph or performing a laser scan while moving along a route set in advance inside the physical building.

The material selection information 149 is generated in advance based on the design data 141, and indicates one or more virtual materials among a plurality of virtual materials of a virtual building. Each virtual material shown in the material selection information 149 will be referred to as a selected material, and these selected materials will be collectively referred to as a selected material group. The selected material group is treated as a representative (a representation) of all the virtual materials. Further, the number of the selected materials is less than the number of all the virtual materials. Therefore, a certain selected material represents a plurality of virtual materials.

For example, if a group of columns is considered as a group as described above, one of the columns may be registered in the material selection information 149 as a selected material. Furthermore, if a column and a beam that are in contact with each other are considered as a group, either one of the column and the beam may be registered in the material selection information 149 as a selected material. The material selection information 149 may be created in this way. To each of the selected materials, information indicating a plurality of virtual materials represented by that selected material can be attached.

The physical material data generating processor 159 is configured to generate the physical material data 142 from a partial region of the measured data 148 corresponding to the selected material group based on the material selection information 149. For example, in the same manner as in the fourth or fifth aspect example, the physical material data generating processor 159 may obtain the data (position, shape, etc.) of the physical material from the measured data 148, and also may perform determination of an association between the virtual materials and the physical materials.

Note that the physical material data generating processor 159 of the present aspect example obtains the positions, the shapes, etc. only for the physical materials respectively corresponding to the selected materials indicated by the material selection information 149, rather than obtaining the positions, the shapes, etc. for all the physical materials, that is, rather than obtaining the positions, the shapes, etc. for all of the physical materials respectively corresponding to all of the virtual materials of the virtual building.

Further, the physical material data generating processor 159 records the attributes (e.g., position, shape, etc.) obtained for the physical materials respectively corresponding to the selected materials as the physical material data 142 of the data structure shown in FIG. 5.

The system 130 of the present aspect example provides a data structure that has the following characteristics or features in addition to those of the data structure of the first aspect example: the data structure of the present aspect example further includes measured data, and material selection information that is generated in advance based on the design data and that shows a part of the plurality of the virtual materials, that is, shows one or more virtual materials among the plurality of the virtual materials; and the material selection information is used in the process of generating physical material data from a partial region of the measured data corresponding to the one or more virtual materials shown by the material selection information.

In addition, a computer-readable non-transitory recording medium that records the data having a structure provided by the system 130 of the present aspect example can be created. The same applies to a program and a computer-readable non-transitory recording medium that records the program.

According to the present aspect example, as in the first aspect example, it is possible to integrate the managements of various types of data and information, and improve the efficiency and the consistency of the managements.

In addition, the present aspect example is capable of generating physical material data corresponding only to a part of all virtual materials (one or more virtual materials) in place of generating physical material data corresponding to all the virtual materials. This makes it possible to reduce the resources required for management and processing. For example, the efficiency of the process of generating the physical material data from the measured data can be improved.

### SEVENTH ASPECT EXAMPLE

The seventh aspect example describes some usage modes of a system that can be implemented by combining several aspect examples. The system of the present aspect example can be used for information management in the field of architecture such as construction control or management, maintenance control or management, and repair control or management. The system of the present aspect example is an integrated system configured by utilizing an combining various techniques and technologies such as a mobile object (e.g., a UAV, an autonomous vehicle, a person, etc.), a surveying instrument (e.g., a total station, an electro-optical distance measuring instrument (also known as a laser rangefinder or a telemeter), a theodolite, a rangefinder), a data processing technique and technology (e.g., SfM, MVS, SLAM, etc.), and a modeling technique and technology (e.g., computer graphics, CAD, BIM, etc.).

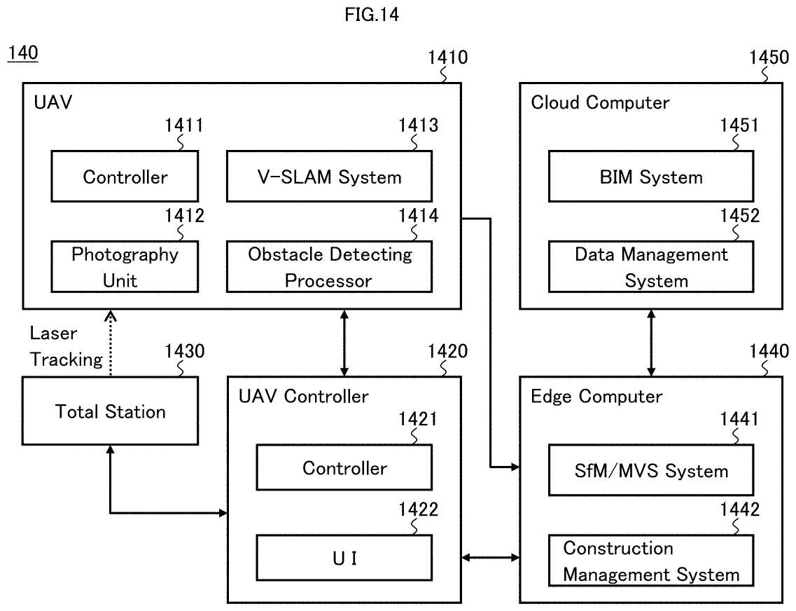

FIG. 14 shows a configuration example of the system according to the present aspect example. The system 140 includes the UAV 1410, the UAV controller 1420, the total station 1430, and the edge computer 1440. The cloud computer 1450 may be included in the system 140, or may be an external device capable of data communication with the system 140. At least one of the UAV1410, the UAV controller 1420, the total station 1430, and the edge computer1440 may be an external device of the system 140.

Note that any of the techniques and/or any of the technologies disclosed in any of the following publications may be combined or incorporated with the present aspect example: U.S. Patent Publication No. 2016/0034137; European Patent Publication No. 3522003; Japanese Unexamined Patent Application Publication No. 2018-116572; Japanese Unexamined Patent Application Publication No. 2018-119882; Japanese Unexamined Patent Application Publication No. 2018-124984; Japanese Unexamined Patent Application Publication No. 2018-151964; Japanese Unexamined Patent Application Publication No. 2019-023653; Japanese Unexamined Patent Application Publication No. 2019-105789; Japanese Unexamined Patent Application Publication No. 2019-194883; Japanese Unexamined Patent Application Publication No. 2019-219206; Japanese Unexamined Patent Application Publication No. 2020-004278; and Japanese Unexamined Patent Application Publication No. 2020-008423. Further, any of the techniques and/or any of the technologies described in Japanese Unexamined Patent Application Publication No. 2018-138922, Japanese Unexamined Patent Application Publication No. 2018-138923, and other known documents or literatures of the related fields, may be combined or incorporated with the present aspect example.

The UAV 1410 is a small unmanned aerial vehicle that makes a flight inside and/or outside a (physical) building to acquire data of the building. The UAV 1410 includes the controller 1411 configured to perform various kinds of controls, the photography unit 1412 configured to acquire data of the building, the V-SLAM system 1413 configured to execute V-SLAM processing, and the obstacle detecting processor 1414 configured to execute obstacle detection processing.

Although details are not shown in the drawings, the UAV 1410 includes elements for making a flight, such as a plurality of propellers and propeller motors configured to respectively rotate the propellers, as with general and standard UAVs. Further, the UAV 1410 may also include any kinds of means that can be mounted on general and standard UAVs, such as an inertial measurement unit (IMU), a device for position measurement, navigation, and timekeeping using a global navigation satellite system (GNSS), although not shown in the drawings. In addition, the UAV 1410 may include an element or a material for automatic tracking of the UAV 1410 using the total station 1430 (not shown in the drawings). The element for the automatic tracking may be a retroreflector such as a prism or a reflective sticker, for example.

The controller 1411 is implemented, for example, by the cooperation of hardware including a processor and a storage device, and control software. The UAV 1410 is capable of autonomous flight under the control of the controller 1411. The UAV 1410 is also capable of remote-controlled flight using the UAV controller 1420 or the like. In the case where the UAV 1410 is remotely controlled, the controller 1411 performs flight control of the UAV 1410 based on operation instruction signals transmitted from the UAV controller 1420 or other controllers. The controller 1411 includes a communication device for performing data communication with other devices such as the UAV controller 1420, the edge computer 1440, and other devices. This data communication is typically wireless communication; however, wired communication may be employed instead or additionally.

The photography unit 1412 may include, for example, any one or more of a digital camera, a laser scanner, and a spectral camera. The digital camera is typically an omnidirectional camera (also referred to as a 360-degree camera or the like). While the present aspect example mainly describes some cases where the photography unit 1412 acquires images (video, moving image, moving picture) of the surrounding environment by an omnidirectional camera detail, the same or similar processing may be performed in other cases as well.

The V-SLAM system 1413 is implemented, for example, by the cooperation of hardware including a processor and a storage device, and V-SLAM software. The V-SLAM system 1413 is configured to perform real time analysis of the video being acquired by the photography unit 1412 to generate three dimensional information of the surrounding environment (e.g., the building) of the UAV 1410, and also perform estimation of the position and the orientation of the UAV 1410. In particular, the estimation is executed to the position and the orientation of the photography unit 1412 of the UAV 1410. The processing executed by the V-SLAM system 1413 may be the same as or similar to any known V-SLAM processing. It should be noted that other techniques or technologies capable of generating the same or similar output as or to that of V-SLAM can be employed as an alternative of V-SLAM.

The obstacle detecting processor 1414 is implemented, for example, by the cooperation of hardware including a processor and a storage device, and obstacle detecting software. The obstacle detecting processor 1414 is configured to detect an image region corresponding to an obstacle (e.g., a tool, a worker, etc.), by inputting an image (frame) constituting the video acquired by the photography unit 1412 into the inference model (learned model) described above. Note that the obstacle detecting processor 1414 may use rule-based processing to detect an image region corresponding to an obstacle. In some aspect examples, the obstacle detecting processor 1414 may be configured to perform obstacle detection by a combination of processing using a learned model and rule-based processing.

The output from the obstacle detecting processor 1414 is input into the controller 1411. The controller 1411 then performs control to avoid a collision with the detected obstacle, based on the output from the obstacle detecting processor 1414. This control may be, for example, any of the following: changing the flight route, levitating (floating on air), landing, switching from autonomous flight to non-autonomous flight, outputting a warning sound, and instructing the UAV controller 1420 to output warning information such as warning sound, warning display, or the like.

The UAV controller 1420 may be used as a remote controller for performing remote control of the UAV 1410. Further, the UAV controller 1420 may be used to display information on the building to be measured, such as a BIM model, a CAD model, material information, a construction plan, and the like. Further, the UAV controller 1420 may be used to output information on the UAV 1410, such as a flight route, a video obtained by the photography unit 1412, a warning, and the like. The UAV controller 1420 may also be used to create or edit a flight plan (flight route) of the UAV 1410.

The UAV controller 1420 includes the controller 1421 and the user interface 1422. The controller 1421 controls each part of the UAV controller 1420. The controller 1421 is implemented, for example, by the cooperation of hardware including a processor and a storage device, and control software. The controller 1421 includes a communication device for performing data communication with other devices such as the UAV 1410, the edge computer 1440, and other devices. This data communication is typically wireless communication; however, wired communication may be employed instead or additionally.

The user interface 1422 includes, for example, a display device, an operation device, an input device, and the like. A typical example of the user interface 1422 is a mobile computer such as a tablet, a smartphone, or the like, and includes a touch screen, a GUI, and the like.

The total station 1430 is used for tracking of the UAV 1410 in flight. In the case where the UAV 1410 includes the retroreflector described above, the total station 1430 performs tracking (or, follows, chases, or pursues) the retroreflector, by outputting tracking light (distance measuring light) and receiving the returned light of the tracking light reflected by the retroreflector. The total station 1430 measures three dimensional coordinates (e.g., a slope distance, a horizontal angle, a vertical angle, etc.) on the basis of the position at which the total station 1430 is installed (or other reference position) while tracking the retroreflector. Such a tracking function is implemented, for example, by the cooperation of hardware including a processor and a storage device, and tracking software. Further, the three dimensional coordinate measurement function is implemented, for example, by the cooperation of hardware including a processor and a storage device, and three dimensional coordinate measuring software.

In the case where the UAV 1410 does not include a retroreflector, the UAV 1410 may include a plurality of light receiving sensors (not shown in the drawings), for example. Each light receiving sensor is capable of receiving the tracking light emitted from the total station 1430. By judging or determining which of the light receiving sensors has received the tracking light, the direction or the orientation of the UAV 1410 with respect to the total station 1430 may be estimated. Such estimation processing may be carried out by any of the UAV 1410, the UAV controller 1420, the total station 1430, and the edge computer 1440, for example.

The total station 1430 includes a communication device for performing data communication with other devices such as the UAV 1410, the UAV controller 1420, the edge computer 1440, and other devices. This data communication is typically wireless communication; however, wired communication may be employed instead or additionally. The total station 1430 is capable of transmitting the position information (three dimensional coordinates) of the UAV 1410, which is sequentially acquired along with the tracking, to the UAV 1410 in real time.

In this way, the UAV 1410 is capable of recognizing its own current position based on the information transmitted from the total station 1430. In addition, the UAV 1410 is also capable of recognizing its own current position based on the information obtained by the V-SLAM system 1413.

When the UAV 1410 is flying in a blind area of the tracking by the total station 1430, the UAV 1410 perceives in real time only the (relatively rough) position information based on V-SLAM.

On the other hand, when the UAV 1410 is in flight in a region other than blind areas, the UAV 1410 may perceive in real time (relatively detailed or fine) position information based on the total station 1430 as well as (relatively rough) position information based on V-SLAM. When both pieces of the position information can be acquired in real time, the UAV 1410 may perform determination of an association between the position information based on the total station 1430 and the position information based on V-SLAM.

Further, the UAV 1410 may be configured to perform autonomous flight with referring to the (relatively detailed) position information based on the total station 1430 while both pieces of the position information can be acquired, and also perform autonomous flight with referring to the (relatively rough) position information based on V-SLAM at other times.

The edge computer 1440 is a computer for implementing edge computing at a construction site, and is configured to process data from devices such as the UAV 1410, the UAV controller 1420, and the total station 1430 at the construction site (or near the construction site). The introduction of such edge computing can eliminate the load increase and the communication delay in the entire system 140.

The edge computer 1440 includes a communication device for performing data communication with a device used at a construction site, such as the UAV 1410, the UAV controller 1420, and the total station 1430. This data communication is typically wireless communication; however, wired communication may be employed instead or additionally.

Further, the edge computer 1440 includes a communication device for performing data communication with the cloud computer 1450. This data communication is typically wireless communication; however, wired communication may be employed instead or additionally.

Further, the edge computer 1440 may include a BIM data processing application and/or a building or construction data management application. In the present aspect example, the edge computer 1440 includes the SfM/MVS system 1441 and the construction management system 1442.

The SfM/MVS system 1441 is implemented, for example, by the cooperation of hardware including a processor and a storage device, as well as SfM software and MVS software. The SfM/MVS system 1441 is configured to create position information of the UAV 1410 (actual flight route) and a three dimensional model of the (physical) building, based on the following data and information, for example: the video acquired by the photography unit 1412 of the UAV 1410; the position information of the UAV 1410 acquired by the V-SLAM system 1413 of the UAV 1410; and the position information of the UAV 1410 acquired by the total station 1430.

The SfM/MVS system 1441 is configured to executes, as SfM processing, estimation of the position information of the UAV 1410 from the video acquired by the UAV 1410 while being in flight. More specifically, the SfM/MVS system 1441 is configured to apply SfM processing to the video acquired by the UAV 1410 while being in flight, to collect time series three dimensional coordinates representing the actual flight route of the UAV 1410 and also obtain the orientation of the UAV 1410 corresponding to each three dimensional coordinate in the time series three dimensional coordinates collected. In other words, the SfM/MVS system 1441 acquires both the time series three dimensional coordinates representing the movement route of the camera included in the photography unit 1412 and the time series orientation information (time series posture information) of the camera along the movement route. The position information (three dimensional coordinates) of the UAV 1410 acquired by the total station 1430 may be referred to in the SfM processing. As a result of this, the precision of the time series three dimensional coordinates and the time series orientation information to be acquired can be improved. The SfM processing of the present example may be the same as or similar to any known SfM processing. Note that another technique or technology capable of generating an output same as or similar to the SfM processing of the present example may be employed as an alternative to the SfM processing.

Further, the SfM/MVS system 1441 executes, as MSV processing, generation of point cloud data of the (physical) building, based on the position information of the UAV 1410 obtained with the SfM processing (e.g., the time series position information and the time series orientation information of the camera) and on the video acquired by the UAV 1410 while being in flight.

In the present aspect example, the edge computer 1440 (the SfM/MVS system 1441, the construction management system 1442, or another data processor) may be configured to detect an image region (material region) corresponding to a building material by inputting an image (frame) constituting the video acquired by the photography unit 1412 into the above-mentioned inference model. In addition, the edge computer 1440 (the SfM/MVS system 1441, the construction management system 1442, or another data processor) may identify material attributes (e.g., type, identification information (ID), shape, position, measurement date, measurement time, etc.) corresponding to each material region detected. Note that the edge computer 1440 may employ rule-based processing for material region detection. In some aspect examples, the edge computer 1440 may be configured to perform material region detection through a combination of processing using a learned model and rule-based processing.

The construction management system 1442 is implemented, for example, by the cooperation of hardware including a processor and a storage device, and construction management software. The construction management system 1442 is configured to perform management of various kinds of data handled or processed by the system 140. The processing executed by the construction management system 1442 will be described later.

The cloud computer 1450 is a computer for implementing cloud computing that provides computer resources in the form of services to the construction site from a remote location via a computer network. The introduction of such cloud computing can improve the extensibility, flexibility, and efficiency of the services that can be provided to the system 140.

For example, the cloud computer 1450 is configured to manage a BIM tool, a data management tool, and data used for these tools (e.g., design BIM data, installation information, construction information, measurement BIM data, etc.), and also provide the tools and the data to the edge computer 1440. In the present aspect example, the cloud computer 1450 includes the BIM system 1451 and the data management system 1452.

The BIM system 1451 is configured to provide various kinds of tools such as BIM tools and various kinds of data such as data used for the BIM tools to the edge computer 1440. The BIM system 1451 is implemented, for example, by the cooperation of hardware including a processor and a storage device, and BIM software. The processing executed by the BIM system 1451 will be described later.

The data management system 1452 is configured to manage various kinds of tools and various kinds of data. The data management system 1452 is implemented, for example, by the cooperation of hardware including a processor and a storage device, and data management software. The processing executed by the data management system 1452 will be described later.

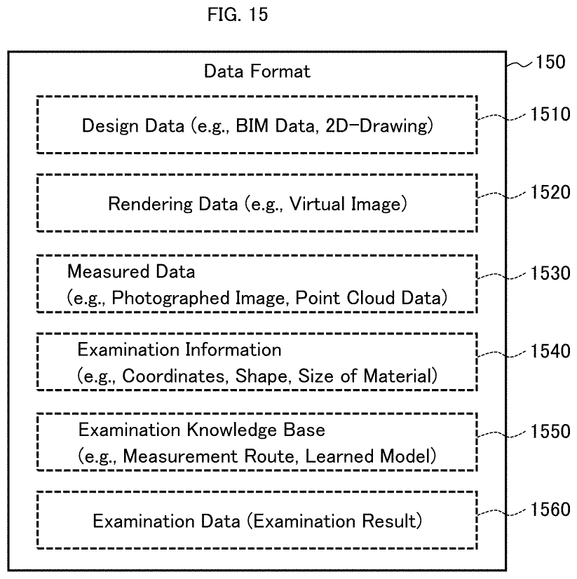

FIG. 15 shows an example of the data structure (data format) handled by the system 140 of the present aspect example. The data format 150 includes the design data 1510, the rendering data 1520, the measured data 1530, the examination information 1540, the examination knowledge base 1550, and the examination data 1560. In other words, the data format 150 has a data structure that includes regions in which at least the above types of data 1510 to 1560 are entered and recorded respectively.

The recording region for the design data 1510 records various kinds of design data described above such as BIM data (design BIM data) and design drawings.

The recording region for the rendering data 1520 records image data (virtual images) obtained by applying rendering to the design BIM data. Rendering data is constructed for each of the plurality of positions in the design BIM data. For example, a plurality of positions may be set on a flight route in advance, and volume rendering with each of the plurality of positions as a viewpoint may be applied to the design BIM data. As a result of this, a plurality of pieces of rendering data (a plurality of virtual images) along the flight route in the design BIM data can be obtained. Corresponding position information (three dimensional coordinates of a corresponding viewpoint in the design BIM data) may be attached to each piece of the rendering data as attribute information. The attribute information of the rendering data is not limited to this. For example, the attribute information of the rendering data may include any information on the design BIM data, any information on the rendering process, any information on the rendering data, or the like.

The recording region for the measured data 1530 records various kinds of data acquired by measurement of the (physical) building. Examples of such data include point cloud data of the building, three dimensional coordinates of each measurement position, video (images) acquired by the photography unit 1412 of the UAV 1410, a two dimensional image, size information, measurement date, measurement time, and the like. Further, parameter information relating to any of the above data examples may also be recorded. For example, parameter information relating to the point cloud data creating process, parameter information relating to the photographing process by the photography unit 1412, and other kinds of parameter information may be recorded.

The recording region for the examination information 1540 records various kinds of information (examination information) for conducting examination of the physical materials respectively corresponding to the virtual materials. The examination information 1540 includes, for example, the shape, size, installation date, installation time, and the like of the examination target (virtual material) at each examination position (position of each virtual material). In other words, the examination information 1540 may include information relating to a plurality of attributes of each virtual material. The examination information is not limited to such data examples, and may include any information relating to the examination.

The recording region for the examination knowledge base 1550 records various kinds of knowledge used for the examination of the physical materials respectively corresponding to the virtual materials. The examination knowledge base 1550 includes, for example, a measurement path (a plurality of examination positions along a flight route), the inference model described above (weight coefficients of a learned model, a neural network model, etc.) and the like. The examination knowledge base 1550 may also include a rule-based algorithm.

The recording region for the examination data 1560 records various kinds of data (examination data) acquired by the examination of the physical materials respectively corresponding to the virtual materials. The examination data 1560 includes, for example, the presence or absence of an object at the examination position (presence or absence of a physical material corresponding to a virtual material), deviation of a physical material with respect to a virtual material (presence or absence of position deviation, direction of position deviation, orientation of position deviation, etc.), and a judgement result of whether an examination position satisfies a predetermined condition. The judgement may include, for example, a judgement of whether or not the examination has been performed based on the data obtained from a flight route set in advance, that is, a judgement of whether or not obstacle avoidance (or deviation from the flight route due to another reason) has been performed at that time point.

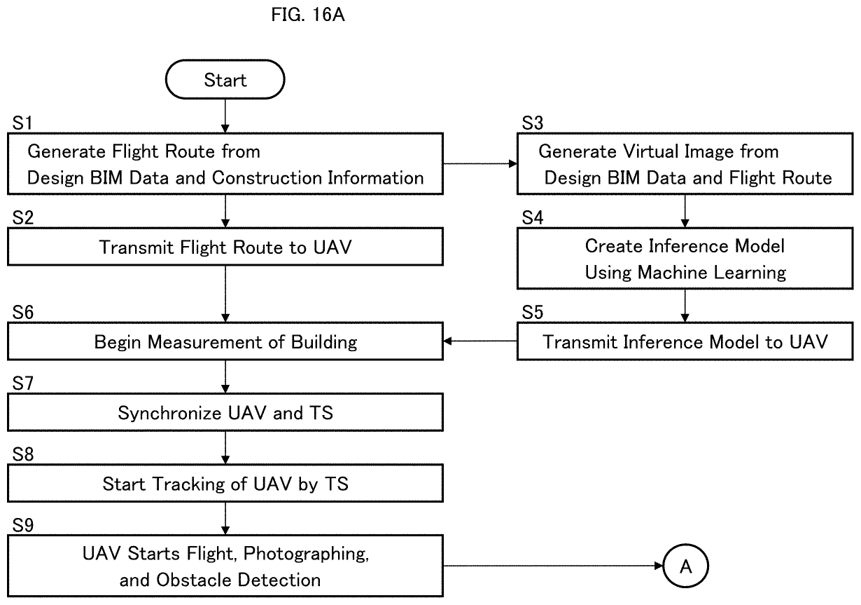

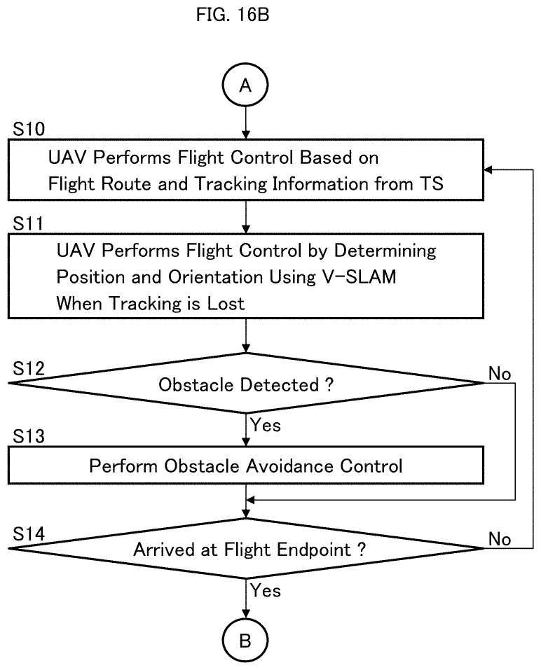

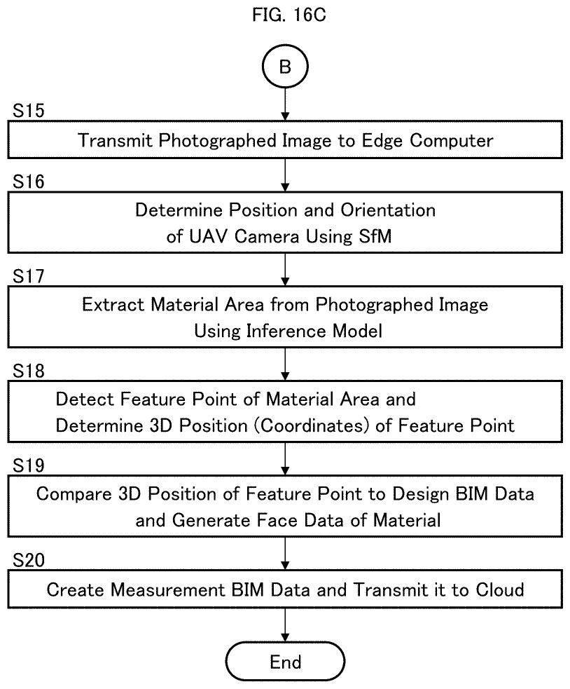

An operation example of the system 140 of the present aspect example will be described with further reference to FIG. 16A to FIG. 16C.

The timings or time points of executing a series of steps or processes (examination) of the present operation example is optional. For example, the examination may be carried out for each predetermined construction process. As an application example, the following series of processes may be performed on each construction day to create a series of data of the construction progress statuses on respective construction days. In the case where the application of the present operation example is only for checking the construction progress, only the examination of determining the presence or absence of a physical material corresponding to each virtual material may be performed. In the case of other applications, the examination may be performed with higher precision.

### (Si: Generate Flight Route)

In the present operation example, first, the cloud computer 1450 transmits the following data to the edge computer 1440: the date of examination to be performed (measurement date information) by the edge computer 1440 (the construction management system 1442) using the design BIM data, the construction information (the installation information; the installation date information for individual materials), and the UAV 1410; obstacle images (virtually generated images, actually photographed images), and the like. The edge computer 1440 determines a flight route of the UAV 1410 on that measurement date based on the information provided from the cloud computer 1450.

The flight route generation may be executed by any of the cloud computer 1450, the UAV controller 1420, and another computer (the same will apply below). Further, the edge computer 1440 or the UAV controller 1420 may generate measurement date information instead of acquiring the above measurement date information from the cloud computer 1450. The flight route generation may be executed as fully automatic processing, semi-automatic processing, or a manual operation. The installation date information may also include installation time.

The flight route may be determined in such a manner that the distance between the photography unit 1412 of the UAV 1410 and examination targets (e.g., materials, floors, ceilings, walls, facilities, columns, etc.) is included within the allowable range, for example. For example, the allowable range (maximum distance, upper limit) may be set in consideration of the fact that the smaller (the closer) the distance is, the higher the examination precision. On the other hand, the allowable range (minimum distance, lower limit) may be set so that the entire building or a broad area of the building can be photographed.

### (S2: Transmit Flight Route to UAV)

For example, upon receiving an instruction form the user, the edge computer 1440 transmits the flight route information generated in the step S1 to the UAV 1410.

### (S3: Generate Virtual Image)

In addition, the edge computer 1440 generates a virtual image (rendering data) by applying rendering to the design BIM data based on the flight route generated in the step S1. For example, the edge computer 1440 generates a virtual video picture to be obtained when a virtual UAV (a virtual camera) flies along the flight route in the three dimensional virtual space in which the design BIM data is defined. More specifically, for each of the plurality of positions on the flight route, the edge computer 1440 generates an image of virtual BIM data (virtual building) to be acquired by the virtual camera from that position.

### (S4: Create Inference Model)

The edge computer 1440 creates an inference model (the first inference model) used for identifying material data from data of the physical building, by applying to a neural network machine learning with training data including the virtual images generated in the step S3 (and a plurality of other virtual images).

Further, the edge computer 1440 creates an inference model (the second inference model) used for identifying data of an obstacle mixed in the data of the physical building, by applying to a neural network machine learning with training data including the obstacle images provided from the cloud computer 1450 in the step Si (and a plurality of other obstacle images).

Note that if performing machine learning with training data including both the virtual images and the obstacle images, a single inference model can be obtained which functions as both the first inference model and the second inference model. Such an inference model is a model created by training for identifying material data and obstacle data from the physical building data. While such an inference model is employed in the following description, adoptable or employable inference models are not limited to this. In addition, an inference model to be adopted may have other functions.

The training data may also include one or both of texture information of materials and texture information of obstacles. Furthermore, the neural network model used for creating the inference model is typically a convolutional neural network (CNN). It should be noted that the method or technique used for inference model creation is not limited to that of the present example. For example, any method or technique such as the following may be employed: support vector machine, Bayes classifier, boosting, k-means clustering, kernel density estimation, principal component analysis, independent component analysis, self-organizing map (or self-organizing feature map), random forest (or randomized trees, random decision forests), and generative adversarial network (GAN).

### (S5: Transmit Inference Model to UAV)

The edge computer 1440 transmits the inference model (e.g., weight coefficients, neural network model, etc.) created in the step S4 to the UAV 1410.

### (S6: Begin Measurement of Building)

After the preparatory steps S1 to S5, the measurement of the physical building begins.

### (S7: Synchronize UAV and Total Station)

In the measurement, first, the UAV 1410 and the total station (TS) 1430 are synchronized with each other. In other words, the clock of the UAV 1410 and the clock of the total station 1430 are synchronized with each other. As a result of the synchronization, the time attached to the video to be obtained by the UAV 1410 and the time attached to the position information of the UAV 1410 to be acquired by the total station 1430 are synchronized with each other. That is, the photographed time and the measurement time are synchronized with each other. Here, the photographed time may be attached to the position information acquired from the video using the V-SLAM processing.

If both the UAV 1410 and the total station 1430 are outdoors, for example, the synchronization of the clocks may be carried out by using a navigation signal from a navigation satellite (including time information based on an atomic clock). On the other hand, if at least one of the UAV 1410 and the total station 1430 is indoors, for example, the synchronization of the clocks may be carried out by using a time server on a network to which both the UAV 1410 and the total station 1430 can connect. Note that the synchronization method or technique is not limited to these.

### (S8: Start Tracking UAV by Total Station)

After the time synchronization in the step S7, the user issues an instruction to start measurement using the UAV controller 1420, for example. The total station 1430 starts tracking of the UAV 1410 that has received the measurement start instruction from the UAV controller 1420. Further, the total station 1430 starts the real time generation of the position information of the UAV 1410 and the real time transmission of the generated position information to the UAV 1410.

### (S9: UAV Starts Flight, Photographing, and Obstacle Detection)

Upon receiving the measurement start instruction in the step S8, the UAV 1410 starts autonomous flight with referring to the flight route received in the step S2, photographing by the photography unit 1412 (and saving the acquired video), and obstacle detection processing by the V-SLAM system 1413 and the obstacle detecting processor 1414.

(S10: UAV Performs Flight Control Based on Information from Outside)

The UAV 1410 performs autonomous flight by flight control based on the tracking information (the position information of the UAV 1410 as the tracking target) transmitted in real time from the total station 1430 and also on the flight route received in the step S2. Note that the series of the steps S10 to S14 is repeated until “YES” is issued as a judgement of the step S14.

(S11: UAV Performs Flight Control Based on Self-Generated Information when Tracking is Lost)

When the UAV 1410 enters a blind area of the tracking by the total station 1430, the UAV 1410 becomes unable to receive the tracking information from the total station 1430, for example. The UAV 1410 may be configured to switch the position information referred to for autonomous flight control from the tracking information from the total station 1430 to the position information sequentially acquired by the V-SLAM system 1413 in response to the loss of the reception of the tracking information. In addition, the UAV 1410 may be configured to switch the position information referred to for autonomous flight control from the position information sequentially acquired by the V-SLAM system 1413 to the tracking information from the total station 1430 in response to the resumption of the reception of the tracking information.

It is conceivable that some tracking information may reach the UAV 1410 due to the reflection or transmission of radio waves even if the UAV 1410 has entered a blind area of the tracking by the total station 1430. Assuming such a case, the UAV 1410 may be configured to detect a problem from the position information indicated by the tracking information. For example, the UAV 1410 may be configured to detect a problem by checking the position information indicated by the tracking information and the position information obtained by the V-SLAM system 1413 against each other. Note that both pieces of the position information have been synchronized as described above. As an example of such a configuration, the UAV 1410 may be configured to calculate an error between the both pieces of the position information (three dimensional coordinates), judges that there is a “problem” if the error is equal to or greater than a predetermined threshold, and judges that there is “no problem” if the error is less than the predetermined threshold. The UAV 1410 may be configured to switch the position information referred to for autonomous flight control from the tracking information from the total station 1430 to the position information sequentially acquired by the V-SLAM system 1413 in response to the shift of judgment results from “no problem” to “problem”. Furthermore, the UAV 1410 may be configured to switch the position information referred to for autonomous flight control from the position information sequentially acquired by the V-SLAM system 1413 to the tracking information from the total station 1430 in response to the shift of judgment results from “problem” to “no problem”.

With such a configuration, the UAV 1410 can perform autonomous flight control based on the positions and the orientations sequentially obtained by the V-SLAM system 1413 while the tracking of the UAV 1410 by the total station 1430 is being lost.

### (S12: Obstacle Detected?)

The operation proceeds to the step S13 if the obstacle detecting processor 1414 detects an obstacle (S12: Yes). While no obstacle is being detected (S12: No), the operation skips the step S13 and proceeds to the step S14.

### (S13: Perform Obstacle Avoidance Control)

When an obstacle has been detected in the step S12 (S12: Yes), the UAV 1410 performs control for the obstacle avoidance operation described above. For example, the UAV 1410 obtains the position, direction, size, etc. of the detected obstacle, determines a route to avoid collision with the obstacle, and flies along the newly determined route. Typically, the start and end points of the collision avoidance route are both located on the flight route received in the step S2. In other words, the UAV 1410 deviates from the flight route received in the step S2, bypasses (dodges) the obstacle, and returns to the flight route.

### (S14: Arrived at Flight End Point?)

The UAV 1410 is capable ofjudging or determining whether or not the UAV 1410 has reached the end point of the flight route received in the step S2 (flight end point) based on the tracking information from the total station 1430, the position information acquired by the V-SLAM system 1413, or the like. When the UAV 1410 has judged that the UAV 1410 has not yet reached the flight end point (S14: No), the operation returns to the step S10. On the other hand, when the UAV 1410 has judged that the UAV 1410 has already reached the flight end point (S14: Yes), the operation proceeds to the step S15. This completes the measurement (photographing) of the physical building.

### (S15: Transmit Photographed Image to Edge Computer)

After reaching the flight end point (S14: Yes), the UAV 1410 transmits, to the edge computer 1440, the photographed images (video) acquired while in flight. Note that the UAV 1410 may sequentially transmit the photographed images to the edge computer 1440 while in flight; or alternatively, the UAV 1410 may accumulate the photographed images during the flight and collectively transmit photographed images to the edge computer 1440 after the completion of the flight. In some aspect examples, the UAV 1410 may repeat the accumulation of photographed images and the transmission of photographed images at predetermined time intervals. In some aspect examples, the UAV 1410 may transmit a predetermined amount of data each time a photographed image is accumulated.

The following steps are a series of processes based on the images acquired by the UAV 1410. That is, the steps S16 to S20 are regarded as post-processing. In the case where the UAV 1410 transmits the photographed images to the edge computer 1440 while in flight, the post-processing may be started before the flight of the UAV 1410 is completed. In other words, the photographing and the post-processing may be performed sequentially in parallel in that case. This can shorten the time required for the operation. On the other hand, in the case where the post-processing is started after the completion of the photographing, the post-processing can be executed with reference to all the photographed images. This can improve the precision and accuracy of the post-processing. For example, when analyzing a particular photographed image, it is possible to refer to one or more photographed images before and/or after the photographed image of interest.

Here, the edge computer 1440 may be capable of judging whether or not the photographed images are suitable for post-processing. For example, the edge computer 1440 may be configured to evaluate or assess the quality of the photographed images, such as brightness, contrast, focus, color, definition, or the like. If the edge computer 1440 judges that the quality is insufficient, the photographing by the UAV 1410 may be performed again, or image processing may be applied to the photographed images to improve the image quality. This image processing may be executed using a learned model created by machine learning, for example. In some aspect examples, the image processing may include interpolation using adjacent photographed images. The edge computer 1440 may start the image quality evaluation while the UAV 1410 is photographing. If the edge computer 1440 judges, during the photographing, that image quality is insufficient, the UAV 1410 may return to the position where the photographed image judged as having insufficient quality was acquired (or to a position upstream from this acquisition position of the photographed image in the flight route) and then perform photography again.

Similarly, the total station 1430 transmits, to the edge computer 1440, the time series three dimensional coordinates and the time series orientation information of the UAV 1410 (the photography unit 1412, the retroreflector) acquired in parallel with the tracking of the UAV 1410.

### (S16: Determine Position and Orientation of Camera)

The edge computer 1440 executes SfM processing based on the photographed images acquired by the UAV 1410 (e.g., each frame of the video) and the time series information acquired by the total station 1430 (e.g., the time series three dimensional coordinates, the time series orientation information), thereby determining the position and the orientation of the photography unit 1412 (e.g., the camera) at each of the plurality of positions on the flight route. Since the UAV 1410 and the total station 1430 have been synchronized in the step S7, the time information of the video and the time information of the time series information may be associated with each other. By performing the determination of the association between the two pieces of the time information, the edge computer 1440 may apply the SfM processing to the combination of the video and the time series information.

(S17: Extract Material Area from Photographed Image)

The edge computer 1440 uses the inference model created in the step S4 to extract an image region (material area, material region), which corresponds to a material (virtual material) included in the design BIM data, from the photographed image (each frame of the video) acquired by the UAV 1410. This extraction process includes, for example, a process of identifying a material area in the design BIM data and a process of masking an image region other than the material area identified. Here, the edge computer 1440 may perform a process of identifying a predetermined attribute of the physical material corresponding to the material area identified.

The edge computer 1440 may judge whether or not the information obtained in the step S17 is suitable for the subsequent processing. For example, the edge computer 1440 makes a judgement as “unsuitable” if no corresponding material areas of physical materials are extracted for a sufficiently large number of virtual materials. Upon receiving a judgement result of “unsuitable”, the edge computer 1440 may perform control for requesting photography again, for example.

### (S18: Detect Feature Point of Material Area and Determine Coordinates of Feature Point)

The edge computer 1440 detects a feature point of the material area extracted in the step S17. The feature point may be any of one or more points, one or more lines, and one or more faces. The feature point may also be a pattern or the like. Further, the edge computer 1440 determines the three dimensional coordinates of the feature point detected.

### (S19: Generate Face Data of Material)

The edge computer 1440 generates face data of the physical material corresponding to the material area extracted in the step S17. For example, the edge computer 1440 performs position matching (registration) of two or more photographed images, which are taken from mutually different photographing positions, based on the feature point detected in the step S18. Typically, these photographed images partially overlap. By using MVS processing, the edge computer 1440 generates face data of a material commonly depicted in these photographed images based on the photographing positions of these photographed images.

A more detailed description will be given now. The edge computer 1440 performs registration between the design BIM data and the video. As a result of the registration, for example, each frame of the video (each photographed image) is embedded in the three dimensional space (the three dimensional coordinate system) in which the design BIM data is defined.

Next, for a predetermined face of the virtual material in the design BIM data, the edge computer 1440 obtains point cloud data in the photographed image located in the vicinity of the predetermined face. For example, the edge computer 1440 identifies point cloud data through the identification of a point in the photographed image in which the distance from a point to the predetermined face of the virtual material is less than or equal to a predetermined threshold. By performing such a process for each frame of the video, three dimensional coordinate point cloud data located in the vicinity of the predetermined face of the virtual material can be obtained.

Subsequently, the edge computer 1440 determines a face in the video corresponding to the predetermined face of the virtual material based on the three dimensional coordinate point cloud data obtained. For example, the edge computer 1440 obtains an approximate face (e.g., a plane, a freeform surface, etc.) based on at least part of the three dimensional coordinate point cloud data. The approximate face thus determined is the face data described above. In other words, the approximate face thus obtained is treated as face data (face image, image of a face) in the video corresponding to the predetermined face of the virtual material. Stated differently, the approximate face is a part (face) of the physical material corresponding to the virtual material, and is treated as a part (face) corresponding to the predetermined face of the virtual material. The edge computer 1440 performs determination of an association between the predetermined face of the virtual material and the face in the video determined based thereon (the face of the physical material). In this manner, an association can be established between a set of virtual materials and a set of physical materials, and also an association can be established between a set of the attributes (e.g., position, shape, etc.) of the virtual materials and a set of the attributes (e.g., position, shape, etc.) of the physical materials.

### (S20: Create Measurement BIM Data)

The edge computer 1440 creates a three dimensional model (i.e., measurement BIM data) based on the plurality of face data generated in step the S19. That is, the edge computer 1440 creates the measurement BIM data based on the data of the plurality of the physical materials obtained in the step S19. The created measurement BIM data is transmitted to the cloud computer 1450 and saved. The measurement BIM data may be used for the comparison with the design BIM data, the construction control or management, the maintenance control or management, the repair control or management, and the like. This concludes the present operation example.

While certain embodiments have been described, these embodiments have been presented by way of example only, and are not intended to limit the scope of the inventions. Indeed, the novel embodiments described herein may be embodied in a variety of other forms; furthermore, various omissions, substitutions, additions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for photogrammetry of a building, comprising:
a memory that stores design data and physical material data, the design data including virtual material information on a plurality of attributes for each of a plurality of virtual materials of a virtual building, and the physical material data relating to the plurality of the attributes for each of a plurality of physical materials and being generated based on measured data acquired from a physical building constructed on the basis of the design data;
a material associating processor configured to generate a plurality of pairs of virtual and physical materials by determining an association between the plurality of the virtual materials and the plurality of the physical materials based on the virtual material information and the physical material data; and
an attribute associating processor configured to determine an association between the virtual material information and the physical material data in accordance with the plurality of the attributes for each of the plurality of the pairs, wherein
the virtual material information includes virtual material position information,
the physical material data includes physical material position data, and
the material associating processor generates the plurality of the pairs based on the virtual material position information and the physical material position data.

2. A system for photogrammetry of a building, comprising:
a memory that stores design data, a virtual image of a virtual building, and physical material data, the design data including virtual material information on a plurality of attributes for each of a plurality of virtual materials of the virtual building, and the physical material data relating to the plurality of the attributes for each of a plurality of physical materials and being generated based on measured data acquired from a physical building constructed on the basis of the design data;
a material associating processor configured to generate a plurality of pairs of virtual and physical materials by determining an association between the plurality of the virtual materials and the plurality of the physical materials based on the virtual material information and the physical material data;
an attribute associating processor configured to determine an association between the virtual material information and the physical material data in accordance with the plurality of the attributes for each of the plurality of the pairs; and
a movement control information creating processor configured to create movement control information for acquiring data of a building using a mobile object based on the virtual image.

3. The system of claim 2, wherein
the memory further stores a photographed image, and
the movement control information creating processor creates the movement control information based further on the photographed image.

4. The system of claim 2, further comprising an inference model creating processor configured to create an inference model for identifying an image of a building material from a photographed image of a building by applying machine learning using at least the virtual image to a neural network,
wherein the movement control information creating processor creates the movement control information based further on the inference model.

5. A system for photogrammetry of a building, comprising:
a memory that stores design data, a virtual image of a virtual building, and physical material data, the design data including virtual material information on a plurality of attributes for each of a plurality of virtual materials of the virtual building, and the physical material data relating to the plurality of the attributes for each of a plurality of physical materials and being generated based on measured data acquired from a physical building constructed on the basis of the design data;
a material associating processor configured to generate a plurality of pairs of virtual and physical materials by determining an association between the plurality of the virtual materials and the plurality of the physical materials based on the virtual material information and the physical material data;
an attribute associating processor configured to determine an association between the virtual material information and the physical material data in accordance with the plurality of the attributes for each of the plurality of the pairs; and
a reference information creating processor configured to create, based on the virtual image, reference information for determining whether data of a building material is acquired when acquiring data of a building using a mobile object.

6. The system of claim 5, wherein
the memory further stores a photographed image, and
the reference information creating processor creates the reference information based further on the photographed image.

7. The system of claim 5, further comprising an inference model creating processor configured to create an inference model for identifying an image of a building material from a photographed image of a building by applying machine learning using at least the virtual image to a neural network,
wherein the reference information creating processor creates the reference information based further on the inference model.

8. A system for photogrammetry of a building, comprising:
a memory that stores design data, a virtual image of a virtual building, physical material data, and data of a building, the design data including virtual material information on a plurality of attributes for each of a plurality of virtual materials of the virtual building, and the physical material data relating to the plurality of the attributes for each of a plurality of physical materials and being generated based on measured data acquired from a physical building constructed on the basis of the design data;
a data object detecting processor configured to detect a data object from the data of the building based on the virtual image;
a material associating processor configured to generate a plurality of pairs of virtual and physical materials by determining an association between the plurality of the virtual materials and the plurality of the physical materials based on the virtual material information, the physical material data, and the data object; and
an attribute associating processor configured to determine an association between the virtual material information and the physical material data in accordance with the plurality of the attributes for each of the plurality of the pairs.

9. The system of claim 8, wherein
the memory further stores a photographed image, and
the data object detecting processor detects the data object based further on the photographed image.

10. The system of claim 8, further comprising an inference model creating processor configured to create an inference model for identifying an image of a building material from a photographed image of a building by applying machine learning using at least the virtual image to a neural network,
wherein the data object detecting processor detects the data object based further on the inference model.

11. A system for photogrammetry of a building, comprising:
a memory that stores design data, representative part information, measured data, and physical material data, the design data including virtual material information on a plurality of attributes for each of a plurality of virtual materials of a virtual building, the representative part information showing a representative part of a virtual material, the measured data being acquired from a physical building constructed based on the design data, and the physical material data relating to the plurality of the attributes for each of a plurality of physical materials and being generated based on the measured data;
a material associating processor configured to generate a plurality of pairs of virtual and physical materials by determining an association between the plurality of the virtual materials and the plurality of the physical materials based on the virtual material information and the physical material data;
an attribute associating processor configured to determine an association between the virtual material information and the physical material data in accordance with the plurality of the attributes for each of the plurality of the pairs; and
a partial region identifying processor configured to identify a partial region of the measured data corresponding to a representative part of one of the plurality of the virtual materials based on the representative part information.

12. The system of claim 11, further comprising a first physical material data generating processor configured to generate the physical material data from the measured data based on the partial region identified by the partial region identifying processor.

13. A system for photogrammetry of a building, comprising:
a memory that stores design data, material selection information, measured data, and physical material data, the design data including virtual material information on a plurality of attributes for each of a plurality of virtual materials of a virtual building, the material selection information showing one or more virtual materials among the plurality of the virtual materials and being generated in advance based on the design data, the measured data being acquired from a physical building constructed based on the design data, and the physical material data relating to the plurality of the attributes for each of a plurality of physical materials and being generated based on the measured data;
a material associating processor configured to generate a plurality of pairs of virtual and physical materials by determining an association between the plurality of the virtual materials and the plurality of the physical materials based on the virtual material information and the physical material data;
an attribute associating processor configured to determine an association between the virtual material information and the physical material data in accordance with the plurality of the attributes for each of the plurality of the pairs; and
a second physical material data generating processor configured to generate the physical material data from a partial region of the measured data corresponding to the one or more virtual materials based on the material selection information.

14. A system for photogrammetry of a building, comprising:
a memory that stores design data and physical material data, the design data including virtual material information on a plurality of attributes for each of a plurality of virtual materials of a virtual building, and the physical material data relating to the plurality of the attributes for each of a plurality of physical materials and being generated based on measured data acquired from a physical building constructed on the basis of the design data;
a material associating processor configured to generate a plurality of pairs of virtual and physical materials by determining an association between the plurality of the virtual materials and the plurality of the physical materials based on the virtual material information and the physical material data; and
an attribute associating processor configured to determine an association between the virtual material information and the physical material data in accordance with the plurality of the attributes for each of the plurality of the pairs, wherein
the virtual material information includes installation date information that shows an installation date for each of the plurality of the virtual materials,
the physical material data includes measurement date information that shows a measurement date of the physical building, and
the material associating processor generates the plurality of the pairs based further on the installation date information and the measurement date information.
